(19) United States
(12) Patent Application Publication
(10) Pub. No.: US 2014/0302617 A1
(43) Pub. Date: Oct. 9, 2014

(54) SAMPLE COLLECTION SYSTEM AND METHOD FOR USE THEREOF

(71) Applicant: JACK L. ARONOWITZ, POMPANO BEACH, FL (US)

(72) Inventor: JACK L. ARONOWITZ, POMPANO BEACH, FL (US)

(21) Appl. No.: 14/309,235

(22) Filed: Jun. 19, 2014

Related U.S. Application Data
(63) Continuation of application No. 13/784,207, filed on Mar. 4, 2013, now abandoned.
Application No. 13/784,207 is a continuation of application No. 13/078,986, filed on Apr. 3, 2011, now abandoned.
Application No. 13/078,986 is a continuation-in-part of application No. 12/212,420, filed on Sep. 17, 2008, now abandoned.
Application No. 12/212,420 is a continuation of application No. 09/193,062, filed on Nov. 16, 1998, now abandoned.

(51) Int. Cl. G01N 1/10; G01N 1/40

(52) U.S. Cl. CPC G01N 1/10; G01N 1/405
USPC 436/178; 422/550

(57) ABSTRACT

A sample collection system capable of collecting, storing and dispensing a liquid sample is disclosed. The collection system includes a collector composed of a material which has the unique ability to express constituents of interest at levels which are much more concentrated than their levels in the fluid samples from which they are expressed, where the expressed highly concentrated sample can then be used with modern rapid screening/testing protocols, such as solid phase assays, to test for the constituents of interest. Thus, it is now possible to obtain analytes of interest, such as the HIV protein antibodies, from saliva samples at concentrations that are detectable with systems and/or devices that are typically utilized only for blood serum or plasma testing. The collector is sized and shaped to fit within a recovery container, which, in turn, is sized and shaped to fit within a collection tube. The recovery container includes an aperture which does not permit passage of fluid under ambient conditions, but facilitates transfer thereof when subjected to pressure. An optional channel within the collection tube facilitates dispensing of the sample for further processing.

### CROSS-REFERENCE TO RELATED APPLICATION(S)

The present application is a continuation application of co-pending application Ser. No. 13/784,207, filed Mar. 4, 2013; which is a continuation application of application Ser. No. 13/078,986, filed Apr. 3, 2011 (now abandoned); which is a continuation-in-part of U.S. application Ser. No. 12/212,420, filed Sep. 17, 2008 (now abandoned), which is a continuation of U.S. application Ser. No. 09/193,062, filed Nov. 16, 1998 (now abandoned), which are hereby incorporated by reference herein in their entireties, including any figures, tables, or drawings.

### FIELD OF THE INVENTION

This invention is directed to sample collection devices for collecting, recovering and storing fluid samples, such as biological fluids, e.g., saliva, and for expressing constituents of interest therefrom at levels which are much more concentrated than their levels in the fluid samples from which they are expressed, and methods of use thereof

### BACKGROUND

The analysis and testing of samples for detection of constituents of interest thereof generally involves initially obtaining a representative sample and, subsequently, transporting the sample to a laboratory for constituent analysis. Typically, a sample is collected via some expedient and transferred to an intermediate device for storage and/or contact with one or more analytical reagents.

For example, in the context of the constituent analysis of a biological fluid sample, the sample is typically collected by invasive procedures (e.g., finger stick or venous puncture of sample donor for a blood sample), or is a biological waste (e.g., urine or stool specimen), depending upon the constituent (i.e., analyte) of interest, and the physical condition of the sample donor. The traditional methods for the invasive collection of biological fluid samples (e.g., drawing blood) is generally restricted to certain controlled and/or laboratory environments. More specifically, the securing of a sample, such as by drawing blood, necessarily involves the consent of the subject, and is often limited in terms of the size of the sample that can be obtained from a subject. Moreover, traditional invasive procedures usually require trained personnel to obtain the sample.

Alternative means of sample collection (e.g., voiding of a urine specimen) may prove to be an unacceptable option due to the unique attributes of a vital, biological fluid sample with respect to the constituents (i.e., analytes) of interest. More specifically, certain types of constituents of interest (e.g., blood borne infections, cholesterol, triglycerides, blood alcohol, etc.) are not readily ascertainable from biological waste and, thus, no acceptable alternative method for analysis exists. Accordingly, the limitation imposed by the foregoing constraints restricts the clinician/investigator to either a vital biological fluid (blood or saliva) or, in the case of alcohol, to a breathalyzer type test.

A vital, biological fluid, such as saliva, is relatively easily obtained, stable, conveniently stored and can contain a number of constituents of interest to both the clinician and to law enforcement. As is known, and common in saliva testing, the sample can be readily obtained by swabbing the buccal epithelial tissues in the donor's mouth, or through the use of a saliva collection device, which can be placed in the donor's mouth for a definitive period of time to allow for the adsorption of saliva thereon.

The use of a collection device is preferred in that it protects the individual collecting the sample from exposure thereto, and otherwise provides a relatively sterile medium in which to transfer the sample for storage, or to subject the sample to analysis.

Traditional methods and devices associated with collection of saliva samples via collection systems suffer from several major drawbacks. First, and most important, traditional methods have not heretofore been capable of providing sufficient concentrations of the analyte of interest to facilitate modern rapid screening/testing protocols, such as solid phase assays (e.g., rapid screen HIV testing). Such methods have produced, even under the most optimum conditions, concentration levels much below that found in blood, which are generally required for such modern screening/testing protocols.

The minimum concentrations of certain drugs or metabolites that must be present in a specimen to qualify as a positive reading have been established by the Substance Abuse and Mental Health Services Administration (SAMHSA). The levels established by SAMHSA are low enough that they can be difficult or impossible to detect with currently available oral fluid testing systems. This is particularly problematic for detection of phencyclidine (PCP or “angel dust”) and tetrahydrocannabinol (THC) found in marijuana, where levels required for a positive reading are particularly low. Additionally, the traditional use of cotton swabs and/or plastics as “absorbents” for saliva collection medium is flawed since such materials will often introduce residual material (e.g., fibers) into the sample, thus potentially adversely affecting the sample and limiting, if not completely precluding, its use. Moreover, the use of a cotton swab is inherently incompatible with the collection and analysis of proteinaceous analytes, or protein bound analytes, in that such materials adsorb and/or otherwise adversely interact with the protein and thereby prevent its later release for detection and analysis.

Another important issue on the forefront of medicine is the increased need to test for HIV infections. It has been determined that while the number of people worldwide contracting HIV has increased, the mortality rate has been reduced because of early detection and more widely available therapy. To increase early detection efforts, the U.S. Centers for Disease Control and Prevention has issued new recommendations that HIV screening be conducted on all patients between 13 and 64 years of age and that it be done in all health care settings, including hospitals, urgent care centers, inpatient service centers, primary care centers, and specialized care centers.

To reduce the number of patients who decline or “opt-out” of such testing, less invasive procedures are needed. A further issue is that in most developing countries, the equipment and staff to run sophisticated tests is limited or non-existent. The use of saliva tests for HIV can be advantageous because they are more readily consented to by patients than invasive venipuncture procedures and they can be administered without the necessity of specialized laboratory facilities.

In view of these and other issues, the use of saliva for constituent analysis has and continues to be a source of considerable interest and investigation because of the presence of numerous constituents of interest in saliva and its accessibility as a test specimen. Unfortunately, the deficiencies in the techniques and devices for its collection has up to now postponed its widespread acceptance as a biological sample of choice.

Accordingly, there is, and remains, a continuing need to enhance devices, and methods associated therewith, for collection of a sample (e.g., saliva) from a donor which provides sufficient concentration levels of the constituent of interest and is thereafter subjected to selective, diagnostic testing with the remainder thereof being stored for future use and testing (e.g., confirmation testing in the case of drugs of abuse).

### SUMMARY OF THE INVENTION

The present invention alleviates and overcomes certain of the above-mentioned drawbacks, shortcomings and disadvantages of the present state of the fluid sample collecting art through the discovery of novel and unique systems for collecting, recovering, and storing fluid samples, such as biological fluids, e.g., saliva, and for expressing constituents of interest therefrom at levels which are much more concentrated than their levels in the fluid samples from which they are expressed, and methods of use thereof.

The systems of the present invention are simple, yet effective and include: (1) a recovery container having an open end and a closed end, which may include a small aperture; (2) a cap having means for engagement and sealing of the open end of the recovery container; and (3) a collector sized and shaped to fit within the recovery container and that can, optionally, be affixed to the inner surface of the cap and extend therefrom into the recovery container, when the cap is engaged with and sealed to the recovery container.

Alternatively, sample collection systems envisioned by the present invention for collecting, recovering, testing, storing and dispensing fluid samples, such as biological fluids (e.g., saliva) include: (1) a collection tube having an open end and a closed end (optionally tapered), and optionally including (1a) a sub-assembly, which comprises a recovery container having an open end and a closed end, including a small aperture, the recovery container having a size and shape to fit within the collection tube; (2) a cap having means for engagement and sealing of the open end of the collection tube; and (3) a collector sized and shaped to fit within the recovery container and that can, optionally, be removably or non-removeably affixed to the inner surface of the cap and extend therefrom into the recovery container.

When an alternative system is assembled in accordance with the present invention, the collector fits within the recovery container, which, in turn, fits within the collection tube. As the cap is screwed onto or otherwise removably attached to the collection tube, the cap and the recovery container can exert a force on the relatively larger collector, expressing some portion of the sample from the collector into the lower end of the collection tube via the aperture of the recovery container.

In accordance with embodiments of the present invention, the sample collection systems are used to collect saliva samples. In this context, a collector can be comprised of a poly foam member of sufficient size and void volume to rapidly collect a saliva sample that is recoverable therefrom in sufficient quantity and for providing sufficient concentration levels of constituents of interest to permit analysis and testing thereof, without elaborate sample preparation or laboratory equipment and utilizing available methods and techniques. It is believed that, because the collectors of the present invention absorb moisture from the saliva samples, but not the analytes under investigation (e.g., hormones, enzymes, vitamins, proteins, etc.) in the saliva samples, they have the unique ability to highly concentrate the analytes into concentrations not heretofore obtainable with traditional sample collection systems available up to now when expressed therefrom. For example, when an analyte under investigation in the saliva is a protein, the collectors have generated, quite surprisingly, testable samples containing protein in concentrations (in mg/ml) that are at an average percentage increase of at least about 200% over the concentrations of protein produced from saliva samples obtained by direct pipette draw. The concentration can be even four to six times higher (or more) depending upon, for example, the amount of sample obtained, the amount of pressure or force applied to the collector, the initial concentration of the sample, and other factors known to those with skill in the art. The concentration of an analyte of interest will usually be more concentrated in the first few microliters of sample obtained from a collector device. As indicated hereinbefore, this unexpected result is believed to be due to the ability of the polymer foam collectors to absorb moisture from the saliva sample without absorbing the analytes of interest in the saliva sample when the saliva sample is expressed therefrom.

As a result, it has been surprisingly discovered that collectors having this ability, as contemplated by the present invention, can provide analyte concentrations from saliva that have been unachievable heretofore. In other words, the present invention now makes it possible to obtain from saliva, an analyte of interest, such as antibodies to HIV, in concentrations that fall within a range that is detectable with systems previously utilized only for blood serum or plasma testing. The significance of this discovery is underscored by the fact that the present invention now permits analytes to be tested easily, noninvasively and reliably from saliva, as opposed to having to resort to invasive blood drawing techniques utilized in the past to obtain testable analyte concentrations. Thus, it should now be appreciated by those versed in this art that the collectors of the present invention have the remarkable ability to concentrate an analyte of interest from saliva to generate an analyte concentration that is as detectable as a sample generally obtained from blood, using the same or similar systems with the saliva sample as typically used with a blood serum or plasma sample, so that the analyte under investigation can be detected from saliva without having to resort to blood as the testing sample.

Also within the contemplation of the embodiments of the present invention, collectors are treated with a wetting agent that has the ability to modify the viscous, fibrous and/or gelatinous nature of saliva samples to produce relatively thin, fluid samples, which are much less viscous and more readily flowable and, thus, easier to collect and process. Such wetting agents are generally believed to break down or somehow affect the saliva components, such as mucopolysaccarides, food particles, cells, cellular fragments, microorganisms and the like present therein, without interfering with the analytes in the saliva under investigation. Examples of such wetting agents include any inert surfactant, such as the Tweens, polyethylene ethyl glycol (PEG), such as PEG 400, and the like. A person with skill in the art and benefit of the subject disclosure would be able discern any of a variety of alternative wetting agents that could be utilized with the embodiments of the subject invention. Such alternatives are contemplated to be within the scope of the subject invention.

Also, in accordance with the present invention, the collectors may be treated with a salivating agent capable of stimulating the salivation glands for enhancing salivation by the test subject upon contact of the subject's mouth therewith. There are a variety of such agents known to those with skill in the art that can be utilized with the subject invention, such as, for example, citric acid and flavors, such as lemon, lime, orange and the like.

In one embodiment of this invention, the recovery container includes a small aperture in the closed end thereof which permits access to or expression of a fluid within the recovery container. This aperture is essentially restrictive of fluid transfer under ambient conditions, thus requiring that a negative or positive pressure be exerted upon the fluid within the recovery container to effectuate the passage thereof through the aperture in the collection tube. In one embodiment, finger-squeezing the sidewalls of the recovery container can provide sufficient pressure to express relatively uniform, or at least semi-quantitative, droplets of fluid. Likewise the collection tube includes an optional channel within its closed end capable of providing access to fluid within the collection tube. Like the aperture of the recovery container, the channel of the collection tube will not permit fluid passage under ambient conditions. The application of a force upon the collection tube, however, will cause fluid to be dispensed from the collection tube for further processing.

In one embodiment of the present invention described herein, the collector is matched to the physical and chemical properties of both the fluid sample and the analytes of interest contained therein, in that it is both capable of rapid absorption and release of the sample and constituent of interest to allow for analysis thereof without any substantial interaction with or permanent adsorption of the constituent of interest. In a specific embodiment of this invention, the collector is comprised of an interconnecting open cell polymer, e.g., polyvinyl alcohol (PVA), foam that is essentially inert (cross-linked) and otherwise unreactive, e.g., non-adsorbent, toward both the fluid sample and the analytes of interest within the fluid sample, such as an interconnecting open cell polymer polyvinyl alcohol foam marketed under the brand name CLINICEL™ and UltraCell™. Moreover, the poly foam material of the collector can be first treated with a salivating agent and a wetting agent, in accordance with the present invention, so as to stimulate the salivation glands to enhance salivation and to modify the fluid sample from its natural viscous, fibrous and/or gelatinous state to a relatively thin and fluid sample, respectively. Accordingly, it has been surprisingly found that the collectors of the present invention provide significantly higher concentrations of constituents of interest, e.g., analytes, from fluid samples than has been achieved using known collection systems available heretofore.

The poly foam material of the collectors, and other comparable or suitable materials, can be formulated or selected, as desired, to have the requisite density, porosity and other physical properties consistent with the inherent characteristics of the absorbed fluid and the contemplated method of sample recovery and analysis. Further, the treated foam collectors can be lyophilized, i.e., freeze-dried, to preserve the chemistry of any added agents or components and can aid in the absorption of a fluid sample.

In another embodiment of this invention, the physical shape of the absorbent foam element roughly parallels the shape of the interior of the sample recovery member and is slightly larger (length and/or width) in size. Although the collector can have a comparatively small profile (generally 50 to 60% of volume of the collection tube), the slightly larger size of the collector provides an important function of the system; namely, the expression of a portion of the sample as a result of fastening the cap to the tubular collection member. As the cap is brought into intimate contact with and fastened to the open end of the collection tube, the force exerted by the cap and the recovery container on the slightly larger collector cause it to be squeezed, compressed, or otherwise deformed, so as to fit within the recovery container, thereby causing the fluid sample to be expressed into the substantially closed end of the collection tube, and providing the sample for further analysis.

In yet another of embodiment of this invention, either the cap and/or the closed end of the collection tube (including the optional aperture) can be further modified to provide a fitting, e.g., sub-assembly, for coupling, physically engaging (mating with), or otherwise operably connecting a fixture, which can include an analyte sensitive element, e.g., test kit. Thus, upon coupling of the collection system and the fixture, it is thereupon possible to direct or focus the dispensing of the fluid contents of the collection system onto the analyte sensitive element within the fixture to facilitate analysis thereof. More specifically, each of the cap and/or the substantially closed ends of the collection tubes of the collection system, and a fixture for an analyte sensitive element, can each be modified to engage the other so as to create a leak proof union of the two and thereby provide a fluid pathway from the collection tube to a fluid receiving component of the fixture for the analyte sensitive element. Thus, subsequent to, or concurrent with, recovery of the fluid sample from the fluid absorbent element (e.g, squeezing the foam via fastening of the cap) in the collection tube of the collection system, it can be directly applied from the reservoir within the collection tube onto the test element without any loss or inadvertent contact with the clinician. Moreover, since only the requisite amount of sample to perform the assay is used, the balance is conserved for re-testing or simply retained within the secure environment of the collection system, thus insuring against its cross-contamination and/or infection of unsuspecting individuals.

In an alternative embodiment, the recovery container, or some portion thereof, can be molded, formed, or otherwise manufactured of a pliable material, such as, but not limited to, soft vinyl or neoprene. After the collector is fitted into the recovery container, the pliable portion of the recovery container can be squeezed between the fingers to express the liquid sample from the collector. An aperture in the closed end of the recovery container allows relatively uniform, or at least semi-quantitative, drops of the liquid sample to be introduced into the collection tube or onto a testing system and/or device. In a still further alternative embodiment, the liquid sample can be expressed onto a test device, such as, by way of non-limiting example, a drug screening device and/or an HIV screening device, which are usually based upon, but not restricted to, immunoassay techniques. The recovery container can be inserted into the collector for storage and further processing of the liquid sample or for disposal.

The volume of saliva that is collected by the fluid absorbent element is a function of: the size of the absorbent element; the composition of the absorbent element; and, of course, the time the element is in contact with the donor. A typical saliva collector of this invention has a fluid absorbent element of sufficient size and fluid capacity to absorb and thereafter release (express) a sufficient volume of saliva (from approximately 100 to 200 microliters) for performance of at least one screening assay and at least one confirmation assay (if required). As more fully set forth herein, the volume of sample contemplated for use in the solid phase immunoassays of interest will generally require at least approximately 50 microliters, and preferably, approximately 100 microliters.

An important feature of the present invention is the ability of the sample collection system to provide the relatively high oncentration levels of sample constituents of interest required for modern rapid testing/screening procedures, such as solid phase assays.

The above features and advantages of the present invention will be better understood with reference to the following Figures, Detailed Description, and Examples. It should also be understood that the particular embodiments and methods illustrating the present invention are exemplary only, and are not to be regarded as limitations of the present invention.

### BRIEF DESCRIPTION OF THE FIGURES

In order that a more precise understanding of the above recited invention can be obtained, a more particular description of the invention briefly described above will be rendered by reference to specific embodiments thereof that are illustrated in the appended drawings. It should also be understood that the drawings presented herein may not be drawn to scale and that any reference to dimensions in the drawings or the following description are specific to the embodiments disclosed. Any variations of these dimensions that will allow the subject invention to function for its intended purpose are considered to be within the scope of the subject invention. Thus, understanding that these drawings depict only typical embodiments of the invention and are not therefore to be considered as limiting in scope, the invention will be described and explained with additional specificity and detail through the use of the accompanying drawings in which:

FIG. 1 is a perspective view of a preferred embodiment of a sample collection system of this invention;

FIG. 2 is an exploded view of the sample collection system of FIG. 1, which includes a sample recovery or collection tube and cap of composite construction;

FIG. 3 is an enlarged view of the closed end of the collection tube of FIG. 2, wherein the closed end of the collection tube includes an orifice which defines a fluid pathway through the end of the collection tube;

FIG. 4 is a perspective view of an embodiment of the sample collection system wherein the collection tube component includes a skirt;

FIG. 5 is a perspective view of an embodiment of the sample collection system in cooperative relationship with a test icon on a testing station;

FIG. 6 is an exploded perspective view of one embodiment of the sample collection system;

FIG. 7 is a perspective view of an embodiment of the sample collection system as an element of a “test kit”;

FIG. 8 is perspective view of the test kit of FIG. 7 in a workstation embodiment;

FIG. 9 is a table outlining the results of a study designed to determine the protein concentration capabilities of the unique collectors of the present invention;

FIG. 10 is a table outlining the results of a study designed to determine the protein concentration and absorbed weight and retrievable volume of unique collectors of the present invention;

FIG. 11 is an exploded perspective view of another embodiment of the sample collection system;

FIG. 12 is a table outlining the percentage yield of protein for the unique collectors of the present invention;

FIG. 13 is a table outlining the protein analysis for the unique collectors of the present invention;

FIG. 14 is a table outlining the results of a study following a Bio-Rad protein assay protocol designed to determine the protein retention capabilities of the unique collectors of the present invention;

FIG. 15 is a table illustrating a standard Bio-Rad absorbance curve for three different BSA standard solutions with known concentrations, i.e., 3 mg/ml, 2 mg/ml and 1 mg/ml;

FIGS. 16A and 16B are a table outlining the results of a study following a Bio-Rad protein assay protocol designed to determine the protein retention capabilities of the unique collectors of the present invention when expressing three different BSA standard solutions with known concentrations, i.e., 3 mg/ml, 2 mg/ml and 1 mg/ml, and water;

FIG. 17 is a table outlining the results of a study designed to determine the protein concentration capabilities of alternative collectors of the present invention.

FIG. 18A is a perspective view of an alternative embodiment of a fastening cap and collector of the subject invention.

FIG. 18B is a front elevational view of the alternative embodiment shown in FIG. 18A.

FIG. 18C is a side elevational view of the alternative embodiment shown in FIG. 18A.

FIG. 18D is a top plan view of the embodiment shown in FIG. 18A.

FIG. 19A is a perspective view of the alternative embodiment in FIG. 18A, shown without the collector.

FIG. 19B is a front elevational view of the alternative embodiment shown in FIG. 19A.

FIG. 19C is a side elevational view of the alternative embodiment shown in FIG. 19A.

FIG. 19D is a top plan view of the alternative embodiment shown in FIG. 19A.

FIG. 19E is a cross-sectional view taken along line A-A in FIG. 19C.

FIG. 20A is a side plan view of one embodiment of a recovery tube.

FIG. 20B is a side plan view of one embodiment of a collection tube that can be utilized with the recovery tube in FIG. 20A. Particularly illustrated are the tapered collar on the interior of the collection tube that mates with the raised lip on the exterior of the recovery tube that allows them to be securely attached and seal the collection tube opening.

FIG. 21 is a photograph showing an embodiment of a sample collection kit according to the subject invention. Illustrated are a recovery container (bottom left), a collection tube (top right) and a cap with attached collector (middle).

FIG. 22 illustrates one procedure for acquiring a test sample utilizing the collection kit shown in FIG. 21.

FIG. 23 illustrates how to interpret results shown on a test strip containing a sample being analyzed for a single constituent of interest.

FIG. 24 illustrates how to interpret results shown on a test strip containing a sample being analyzed for multiple constituents of interest.

### DETAILED DESCRIPTION OF THE INVENTION

By way of illustrating and providing a more complete appreciation of the present invention and many of the attendant advantages thereof, the following detailed description and examples are provided concerning the novel sample collector systems, embodiments, alternatives and methods.

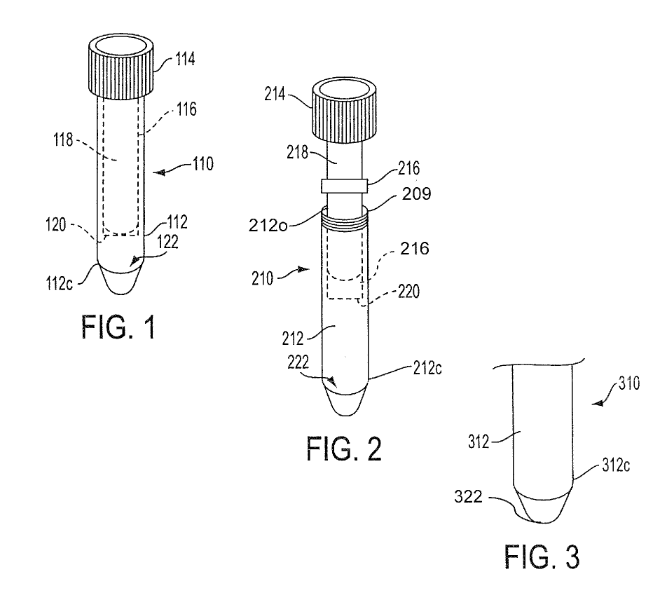

For ease of understanding and continuity of expression, a numerical reference has been assigned to each component part of the system of this invention based upon the function of the component in the system. Thus, a component of a specific combination having the same function in the combination is present in a system of more than one of the FIGS., the last two numbers of the assigned reference numeral will be the same in each of the FIG. where such common function is illustrated. For example, in applying this convention to the functional component of the sample collection system designated as a “cap” (which is functionally designated with the numerical reference “114” in FIG. 1), the caps of the collection system in subsequent FIGS. are thus labeled with related reference numerals ending in “14” (e.g., “214” for FIG. 2, “314” for FIG. 3, and so on).

As is discussed more fully herein, the design and operation of the various components of the sample collection system all cooperate to collect a fluid sample (e.g., saliva) including one or more constituents of interest in sufficient volume and at a higher concentration than normally representative of the environment from which it has been obtained, and thereafter permit recovery of an aliquot of such fluid sample for constituent analysis. Importantly, such aliquot of fluid sample is provided by the collection system of the present invention, such that the constituent(s) of interest are sufficiently concentrated to levels that are detectable with systems and/or devices that are typically utilized only for blood serum or plasma testing, such as, for example, modern rapid screening/testing protocols, such as solid phase assays.

The present invention incorporates these multiple functions into a single, yet simple system. Now referring to FIG. 1, the basic structure of the system 110 is illustrated. The system 110 is comprised of four (4) primary components: (1) a collection tube 112; (2) a cap 114 for, alternatively, sealing and accessing the collection tube 112; (3) a recovery container 116 shaped and sized to seat within the collection tube 112; and (4) a collector 118 for collection (adsorption) of a liquid sample, (e.g., a biological fluids sample, such as saliva).

The recovery container 116 has one or more apertures 120 associated with its lower portion to permit passage of the sample from the recovery container 116 to the collection tube 112 or to a testing system and/or device. The collection tube 112 has an optional channel 122 associated with it so as to provide an alternative method of obtaining an aliquot of the sample from the collection tube 112. Each of the four primary elements will be discussed below.

A.) Collection Tube

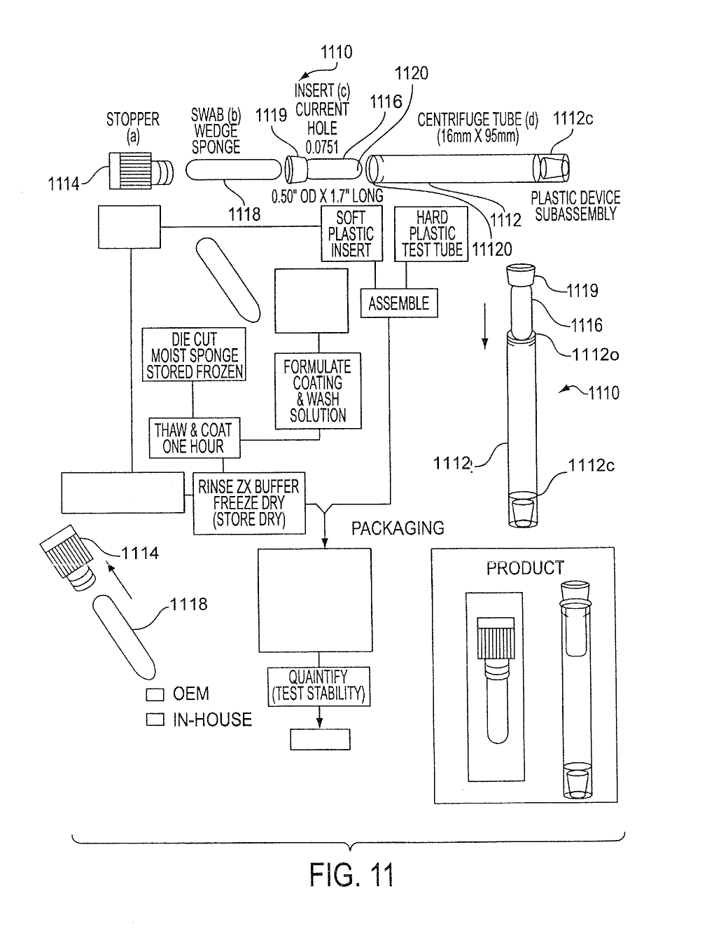

Now referring to FIG. 2, in each of the embodiments of this invention, the collection or centrifuge tube 212 has an open end 212o and a closed end 212c. The open end 212o of the collection tube 212 is of sufficient diameter to accommodate the insertion and removal of a recovery container 216 (discussed below), and is further provided with either external threads 209, or an equivalent, such as, but not limited to, snaps, inter-locking teeth, tapered fit or the like, for sealing engagement by a screw lid or complementary snap, inter-locking or tapered cap 214 (discussed below), such as also shown in FIG. 11.

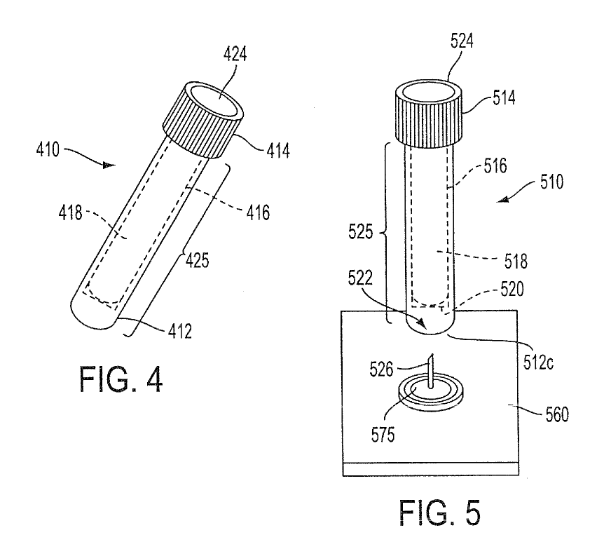

Referring now to FIGS. 1, 2 and 11, the collection tube 112 or 212 or 1112 of the collection systems 110, 210 or 1110, respectively, can have a tapered bottom configuration, depending upon its intended uses, a flexible (and resilient) sidewall construction and versatility for configuration with other functional components of the system. In another of the alternative embodiments of this invention, the collection tube 112, 212 or 1112 can be prepared from a relatively rigid material, such as, but not limited to, thermoset plastic or glass, linear polyethylene or other appropriate material or combinations thereof In alternative embodiments, an optional fixture (shown in FIGS. 4 and 5) is associated with the collection tube 112 to assist with dispensing an aliquot of the sample for further processing.

An optional feature of the embodiments of the sample collection system of the present invention is the presence of a channel 122 within the closed end 112c of the collection tube 112. As further illustrated in FIG. 3, the channel 322 is preferably centrally located within the closed end 312c of the collection tube 312. The channel 322 is preferably shaped and sized such that the sample will not leak from the collection tube 312 under ambient conditions. However, if the collection tube 312 is subjected to pressure, e.g, during centrifuging, an aliquot of the sample may be obtained via the channel 322. Optionally, a screen (not shown) or other selective pass-through device may be used in connection with channel 322 to filter the sample as it is being removed from the collection tube 312. Although a channel appearing within the surface of the closed end 312c of the collection tube 312 is described herein, it is noted that the present invention contemplates the use of other means for accessing/preventing access to the sample via the collection tube 312, including, by way of illustration and not limitation, the use of a tapered dispensing tip (with optional quantitative marks for measuring sample volume), a pressure-activated valve, pierceable septa, e.g., vacuum collection tubes, or other suitable devices.

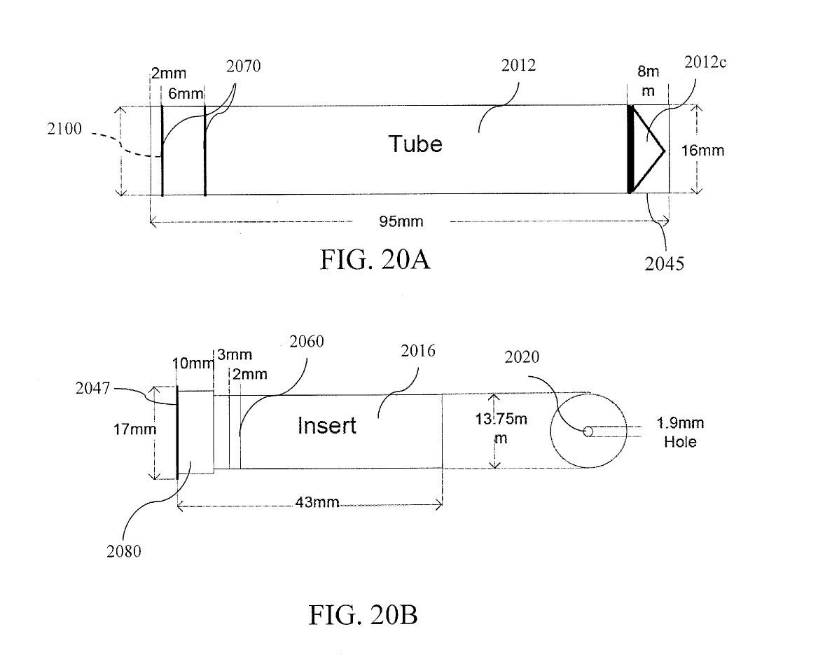

An alternative embodiment, an example of which is illustrated in FIGS. 4 and 20A, the collection tube can have a stand 2045 and 2145, respectively, incorporated at or about the closed end 412c of the collection tube. In one embodiment, the stand extends around all or some portion of the closed end. In a further embodiment, the stand extends beyond the closed end of the collection tube. In a still further embodiment, the end of the stand that extends beyond the closed end of the collection tube is configured to act as a support, allowing the test tube to be maintained in a vertical position unassisted, at least temporarily. As illustrated in FIG. 11, the stand can also be utilized to secure a centrifuge cup at the closed end during centrifugation, to collect a sample aliquot as it exits a channel 122 in the closed end of the collection tube.

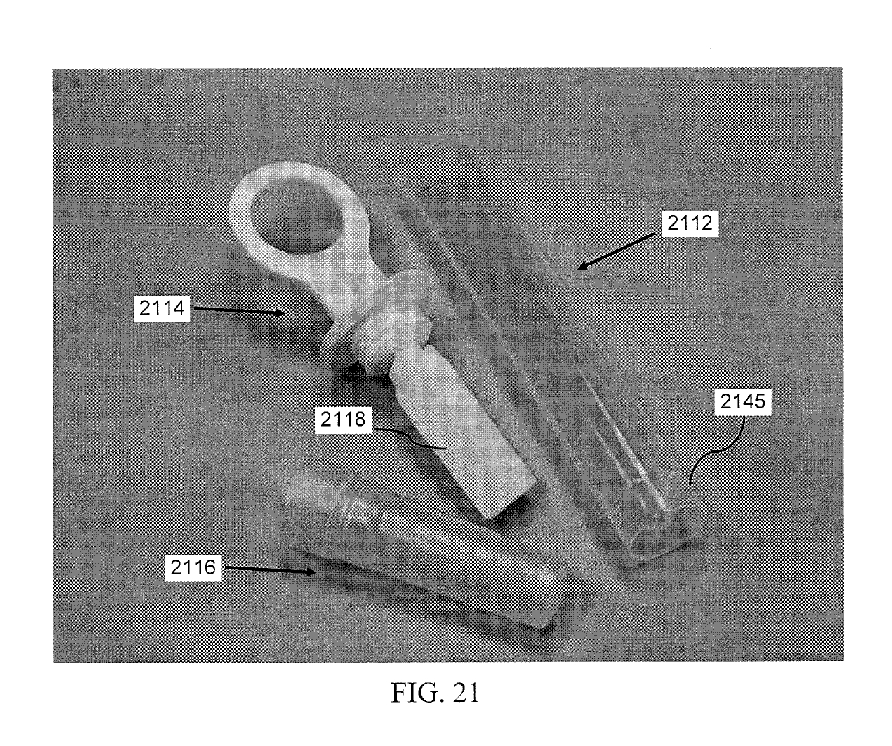

In a specific embodiment, an example of which is illustrated in FIG. 20A, the collection tube is approximately 95 mm in length and with an outside diameter of approximately 16 mm. In a further specific embodiment, the closed end of the tube has a taper approximately 8 mm in length. In a still further specific embodiment, a stand 2045 is affixed around the closed end of the collection tube. In a yet further specific embodiment, as seen in FIG. 20A, the stand extends beyond the tapered closed end of the tube and has a diameter equal to or approximately equal to the outside diameter of the tube. FIG. 21 illustrates an exemplary embodiment of a collection tube of the subject invention.

B.) Cap

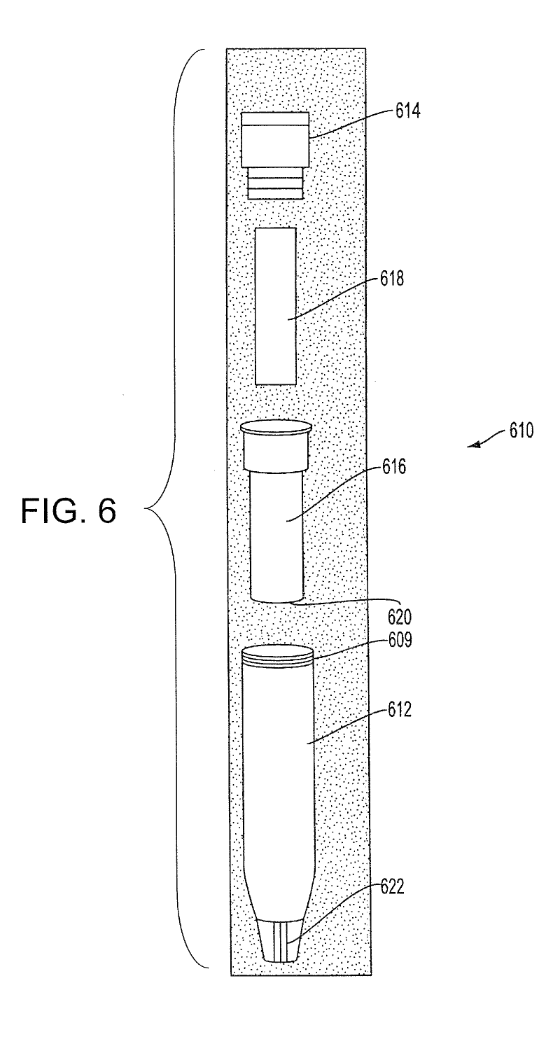

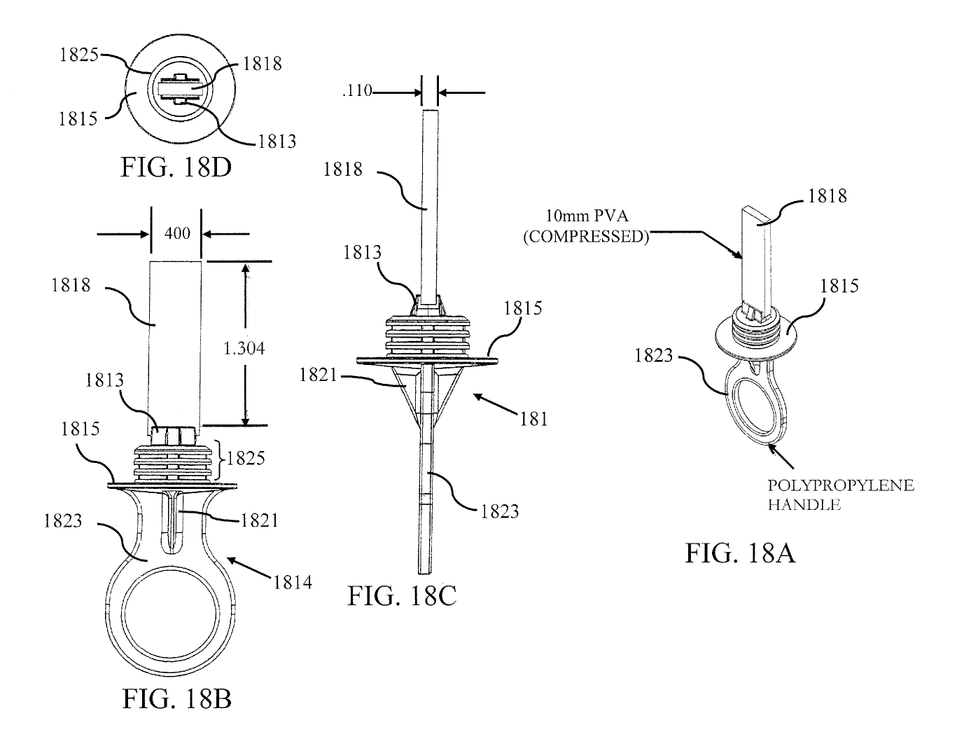

As illustrated in FIG. 2, an exploded view of the sample collection system of FIG. 1, the cap 214 can be of composite construction and can further be, optionally, removably (or permanently) attached to the collector 218 of the sample collection system 210. In FIG. 6, there is shown an embodiment of the collection system 610 having the collector 618 separate from the cap 614. In FIG. 11, a cap or stopper 1114 is depicted which is separate from the collector 1118. In FIGS. 18A-D a cap or stopper is depicted having the collector 1118 affixed to the interior of the cap 1814. In a further embodiment, a collector collar 1813 is fixedly attached to the cap, as shown, for example, in FIGS. 18A-D. The collector collar 1813 permits the collector 1818 to be fixedly or removably attached to the interior of the cap. In a particular embodiment, the collector collar 1813 facilitates heat sealing of the collector collar to the cap. In a more particular embodiment, the collector collar supports attachment via heat sealing of a polyvinyl alcohol (PVA) foam collector. This technique secures the collector to the collector collar, which can make sampling easier. This technique can also reduce manufacturing steps and costs associated therewith.

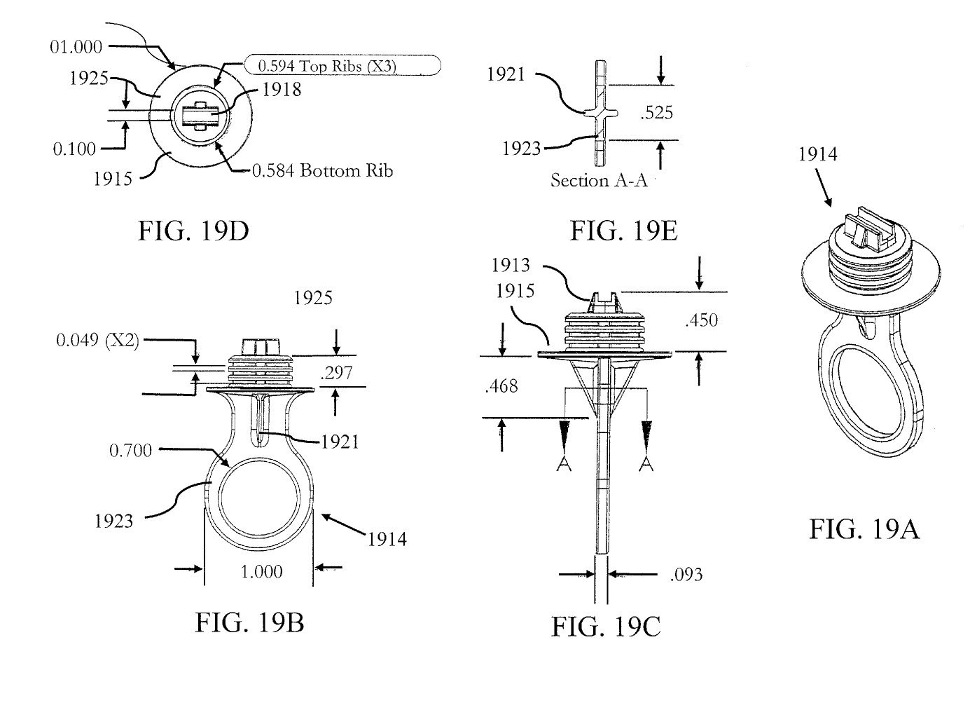

The collector collar 1813 can be, in general, a receptacle for receiving one end of the collector. Thus, the collector collar can have a hollow interior into which the end of the collector can be fitted. In one embodiment, the collector collar can be a receptacle with sides and a hollow interior. In a particular embodiment, an example of which is illustrated in FIGS. 18A-D, the collector collar is a U-shaped receptacle into which the collector is seated and/or affixed. In this embodiment, the collector collar has two parallel arms for contact with the collector. In a specific embodiment, shown, for example, in FIGS. 19A-E, the arms have a length of between approximately 0.10″ and 0.20″ with a distance therebetween of between approximately 0.08″ and approximately 0.15″. In a more specific embodiment, the arms have a length of approximately 0.15″ and have a distance therebetween of approximately 0.10″. Alternative embodiments can utilize more than two arms or perpendicular sides to contact the collector. A person with skill in the art and having benefit of the subject disclosure would be able to determine any of a variety of configurations for a collector collar that can be utilized with the subject invention. Such alternatives are contemplated to be within the scope of the subject invention.

Referring now again to FIG. 2, in this embodiment of the collection system 210, the open end 212o of the collection tube 212 is provided with a threading 209 complementary to threading (not shown) along the interior of the cap 214. When mated (via screwing the collection tube 212 within the cap 214), the open end 212 of the collection tube 212 and the cap 214 form an air tight seal to prevent leakage and/or contamination of a collected sample.

In an alternative embodiment, shown, for example, in FIGS. 18A-D, the cap can comprise a plug 1825 that is press-fitted into the interior of the open end of the collection device, such that it contacts the interior of the recovery tube and/or the collection tube. The shape of the plug can be complementary to the interior configuration of the recovery and/or collection tube, so that when the plug is inserted, an air-tight and/or fluid-tight seal is formed. In one embodiment, the plug is formed of one or more circular fins or ribs that separately form a generally contiguous contact with the interior wall of the recovery tube 116 and 616. In a specific embodiment, shown, for example, in FIGS. 19A-E, the height of the plug is between approximately 0.2″ and approximately 0.3″ and has a diameter of between 0.4″ and 0.6″. In a more specific embodiment, the height of the plug is approximately 0.297″ with a diameter of approximately 0.594″. In a further more specific embodiment, the fin or rib closest to the cap has a diameter of 0.584″, to facilitate seating within the open end of the recovery and/or collection tube.

Once a sample has been acquired from a subject, the collector 1818 is placed into the collection system, preferably with little or no contamination there between. To facilitate this transfer, the cap can have one or more structures to ensure safe and proper handling of the sample. In one embodiment, shown, for example, in FIGS. 18A-D, the exterior of the cap can employ a handle 1823 for use in holding or gripping the cap during the transfer into the collection system. In a further embodiment, the handle 1823 can be a generally flattened extension fixedly attached to the top end of the cap. The handle can further have one or more supports or gussets 1821 and 1921 attached thereto, as shown, for example, in FIGS. 18A-E and 19A-E, respectively. In a particular embodiment, one or more gussets 1821 and 1921 are positioned so as to support or be supported by the length of the handle, as well as to maintain the shape of the handle flange, discussed below. FIGS. 18A-D and 19A-E show one embodiment of a handle that utilizes two gussets approximately 0.468″in length. The selection of an appropriate type of gusset, support, and similar structure is within the competence of those skilled in the art, as are its dimensions for the intended purpose.

The handle can be made from any of a variety of materials, such as, for example, various plastics, polypropylene, nylon, paper, cardboard, or other wood products, ceramics, glass, or combinations thereof. In a specific embodiment, the handle is molded polypropylene fixedly attached to the cap or handle flange, which will be discussed below. In an alternative embodiment, the handle is removably attached to the cap. By way of further example, the figures show a handle with a distal end widened with an open center portion, to form a ring. In a specific embodiment, shown, for example, in FIGS. 19A-E, the length of the handle is between approximately 0.75″ to approximately 1.5″, the width of the handle, at its widest point, is between approximately 0.75″ to approximately 1.5″ and the thickness of the handle is between approximately 0.1″ to approximately 0.15″. In a specific embodiment, the length of the handle is approximately 1.5″, the width of the handle, at its widest point, is approximately 1.0″ and the thickness of the handle is approximately 0.093″. In a further specific embodiment, the open center that forms a ring has a diameter of between approximately 0.500″ and 0.8″. In a more specific embodiment, the open center that forms a ring has a diameter of 0.700″. During the collection of a sample, it can be desirable to ensure that the sample does not contact anything other than the collector or the interior of the collection system. As will be explained below, it can also be advantageous to know when the recovery container has been properly inserted within the collection tube. In a further embodiment, the exterior of the cap can be widened to form a flared or widened handle flange 1815 around the periphery of the cap and/or handle, such as shown, for example, in FIGS. 18A-D. Alternatively, the handle flange can be a separate component for coupling with the handle and/or cap, by techniques and methods known to those with skill in the art. The handle flange can be of any desirable thickness, depending upon the type of material utilized. In a particular embodiment, the flange is of sufficient thickness to maintain flared shape for adequate protective purposes. The handle flange 1815 can have any of a variety of circumferential shapes, such as, by way of example, circular, oval, rectangular, triangular, or other polygonal shape. In a specific embodiment, shown, for example, in FIGS. 19A-E, the flange 1915 has a circular circumferential shape. In a more specific embodiment, the flange has a diameter of approximately 0.7″ to approximately 1.5″ and a thickness of approximately 0.03″ to approximately 0.07″. In a still more specific embodiment, the flange has a diameter of 1.0″ and a thickness of approximately 0.05″.

Referring now to FIG. 11, in this embodiment of the collection system 1110, the open end 1112o of the collection or centrifuge tube 1112 is tapered internally which is complementary to the tapering (not shown) along the exterior of collar 1119 of recovery tube 1116. When mated via tapering, i.e., the exterior of the collar 1119 of recovery tube 1116 and the tapered interior of collection tube 1112, the open end 1112o of the collection tube 1112 and the recovery tube 1116 form an air tight seal to prevent leakage and/or contamination of a collected sample expressed into the collection tube 1112.

FIG. 20B illustrates an alternative embodiment wherein the recovery container 2016 includes one or more raised ridges 2060 on the exterior surface, near the open end. Conversely, the interior 2100 of the collection tube 2012 has one or more raised ribs 2070 near the open end. When the recovery container is inserted into the collection tube, the ridges 2060 of the recovery tube mate with raised rib 2070 in the collection tube to form an airtight seal.

Alternate embodiments of the invention optionally include holes, vents or channels (424 and 524 in FIGS. 4 and 5, respectively) in the cap 214 to permit vapor and/or gas (e.g., air) that is trapped within the sample recovery tube 212 to be expelled at the time of releasing the sample from the sample absorbent medium into the collection tube 212.

C.) Recovery Container

As illustrated in FIG. 2, the recovery container 216 is sized and shaped to fit and seat within the collection tube 212 and receive the collector 218. Preferably, but not mandatory, having a flexible sidewall construction for finger squeezing, the recovery container receives the slightly larger collector 218 and, as more fully described below, plays a role in providing expression (release) of specimen from the collector 218 to collection tube 212.

In one embodiment, the recovery container is molded, formed, or otherwise manufactured of a pliable material that can be compressed with the fingers, such as, but not limited to, soft vinyl or neoprene. It should be appreciated by those of skill in this art that any materials suitable for permiting the sidewall construction of the recovery container, designated for example as 116, 216, 616 and 1116, to be finger squeezed can be utilized for purposes of expressing the fluid sample from the collector and assisting the flow of the fluid sample.

The one or more apertures 220 of the recovery container 216 are preferably shaped and sized such that the sample will not leak from the recovery container 216 under ambient conditions. However, if the recovery container 216 is subjected to negative pressure, e.g., during centrifuging, an aliquot of the sample may be obtained via the aperture 220. In a particular embodiment, illustrated for example in FIG. 20B, the aperture 2020 is located at or near the closed end of the recovery container.

In one embodiment, the aperture in the recovery container is sized to allow release of fluid therein in droplet form, when a slow steady pressure is applied to the walls of the recovery container. This can prevent or reduce the release of a stream or “squirt” of fluid, which can be undesirable when used with certain testing systems. In a further embodiment, the size of the aperture can be calibrated to allow expression of fluid droplets of at least near uniform size or in at least semi-quantitative amounts. Advantageously, this can allow a more precise amount to be expressed and can reduce or eliminate the need to measure the volume of sample applied to a testing system and/or device. Expressing a pre-determined number of droplets can ensure that a consistent sample size is introduced into the collection tube or onto a testing system and/or device.

For example, the volume of sample required in the solid phase immunoassays often used with blood serum or plasma samples is usually at least approximately 50 microliters, and preferably, approximately 100 microliters. In one embodiment, the aperture 2020 in the recovery container can produce droplets sizes of approximately 50(+5) microliters. Thus, with this embodiment, one to two drops of fluid, finger-squeezed from the recovery container, can ensure an adequate sample size. However, some testing systems and/or devices may require more or less sample volume. Thus, the size of the aperture can be modified to produce smaller or larger droplet sizes as may be required for a particular testing system and/or device. By way of further example, HIV testing systems are typically very sensitive to the protein analyte of interest and may require less sample volume to obtain an accurate test result. Thus, the aperture size could be modified accordingly.

Typically, the first few drops of fluid obtained by finger-squeezing or centrifuging a collector of the subject invention can have the highest concentration of the analyte(s) of interest. Successive drops from continued finger-squeezing or other application of pressure can also have sufficient concentration, as described above, but may not be as concentrated as the first few drops obtained. Continued pressure applied to the collector can extract additional fluid, but the concentration of the analyte of interest can be further reduced and may fall below the concentration threshold necessary for detection with systems and/or devices most often used for blood serum or plasma testing.

The size of the aperture can depend upon the overall size of and the material utilized for the recovery container, as well as the desired volume and viscosity of sample fluid. For example, if the material of the recovery container is relatively flexible, pressure applied by finger-squeezing may require an aperture that is smaller than one that would be required for a more rigid material, in order to obtain droplets of desired volume. However, the viscosity of a fluid sample, e.g., saliva, can vary, even after being liquefied. Therefore, the amount of pressure applied to the recovery container in order to obtain the desired droplet volume and a testable sample can vary. A person with skill in the art and having benefit of the subject disclosure would be able to determine an appropriate aperture size based upon the size and type of material utilized for the recovery container.

In one embodiment, the diameter of the aperture 220 is between approximately 1.0 mm and 2.0 mm. In a more particular embodiment, the diameter of the aperture is between approximately 1.5 mm and approximately 2.0 mm. A still more particular embodiment utilizes an aperture having a diameter of approximately 1.9 mm.

Although an aperture appearing within the surface of the closed end of the recovery container 216 is described herein, it is noted that the present invention contemplates the use of other means for accessing/preventing access to the sample within the recovery container 216, including, by way of illustration and not limitation, the use of a tapered dispensing tip (with optional quantitative marks for measuring sample volume), a pressure-activated valve, pierceable septa, e.g., vacuum collection tubes, or other suitable devices could be utilized for gaining access to the sample.

The slightly smaller length and circumference of the recovery container 216 as compared with the collector 218 provides the pressure required, upon placement and attachment of the cap 214, to release a portion of the sample held within the collector 218 into the lower portion of the collection tube 212.

It should of course be understood that when the recovery container 216 is designed with a flexible side wall construction, it may be finger squeezed to express the fluid sample, e.g., saliva, absorbed onto the collector 116, as detailed above.

As illustrated in FIG. 11, the recovery container 1116 is sized and shaped to fit and seat within the collection tube 1112 and receive the collector 1118. Preferably, but not mandatory, having a flexible sidewall construction for finger squeezing, the recovery container 1116 receives the slightly larger collector 1118 and, as more fully described below, plays a role in providing expression (release) of specimen from the collector 1118 into collection tube 1112.

In a further embodiment, the recovery container 2016 can include an overlap or lip 2047 around the periphery of the open end, as illustrated for example, in FIG. 20B. The lip can provide further protection against leaks and prevent the recovery container from being inserted too far into the collection tube 2012. In a specific embodiment, shown, for example, in FIG. 20B, the lip has a diameter of approximately 17 mm.

In a further embodiment, mentioned above, the recovery container is formed with one or more raised ridges 2060 on the exterior of the sidewall. The ridges 2060 are designed to mate with one or more raised ribs 2070 on the interior 2100 of the collection tube, as shown, for example, in FIG. 20B. When the recovery container is seated within the collection tube, the mating of the raised ribs and the ridges forms an airtight seal between the recovery container and the collection tube.

To facilitate seating of the recovery container within the collection tube, the recovery container can have a larger diameter nearer the open end. FIG. 20B illustrates an example of this embodiment, wherein the sidewall near the open end is expanded to a larger diameter to form a collar 2080. In a further embodiment, the collection tube can have additional raised ribs 2070 that can press against the expanded sidewall around the recovery container opening to form an airtight seal. In a specific embodiment, shown in FIG. 20B, the collar 2080 is located nearer to the open end and is approximately 10mm in length.

In a specific embodiment, an example of which is shown in FIG. 20B, the recovery container 2016 has a total length of between approximately 40 mm and 45 mm. More particularly, the recovery container has a length of approximately 43 mm. The diameter of the recovery container is between approximately 13 mm and 14 mm. In more specific embodiment, the diameter of the recovery container is approximately 13 mm. However, as discussed above, the diameter of the recovery container is larger around the collar 2080.

The aperture 1120 of the recovery container 1116 is preferably shaped and sized, e.g., between approximately 0.075″ and 0.1″, such that the sample will not leak from the recovery container 1116 under ambient conditions. However, if the recovery container 1116 is subjected to negative pressure, e.g., during centrifuging, an aliquot of the sample may be obtained via the channel 1120. Although an aperture appearing within the surface of the closed end of the recovery container 1116 is described herein, it is again noted that the present invention contemplates the use of other means for accessing/preventing access to the sample within the recovery container 1116, including, by way of illustration and not limitation, the use of a tapered dispensing tip (with optional quantitative marks for measuring sample volume), a pressure-activated valve, pierceable septa, e.g., vacuum collection tubes, or other suitable devices.

The slightly smaller length and circumference of the recovery container 1116 as compared with the collector 1118 provides the pressure required, upon placement and attachment of the cap 1114, to release a portion of the sample held within the collector 1118 into the lower portion of the collection tube 1112.

It should again be understood that when the recovery container 1116 is designed with a flexible side wall construction, it may be finger squeezed to express the fluid sample, e.g., saliva, absorbed onto the collector 1116.

FIG. 21 illustrates an exemplary embodiment of a recovery container of the subject invention.

D.) Collector

Referring again to FIGS. 1 and 11, as previously noted the sample collection system 110 or 1110 of this invention is capable of use in a variety of environments and thus its specific construction is dictated accordingly. More specifically, where the collection system 110 or 1110 is to be used to collect a fluid sample containing a hazardous waste comprising a highly acidic substance of organic substance, the materials selection for the components of the collection system 110 or 1110 must be resistant to degradation by the sample. Similarly, where the collection system 110 or 1110 is to be used in the collection of a biological fluid, such as saliva, the materials selection for the collection tube and the collector 118 or 1118 must exhibit at a minimum the following characteristics: (1) inert with respect to proteins, vitamins, enzymes, hormones and other like constituents of interest (collectively “analytes”) of the sample; (2) not subject to ingestion or chemical breakdown from intimate contact with enzymes or other components contained in the saliva; (3) not capable of leaching any substances into the mouth of the donor during collection or thereafter; (4) capable of rapidly collecting and subsequently releasing a biological fluid to allow for the analysis of the constituents contained therein; (5) capable of modifying the sample collected from its viscous, fibrous and/or gelatinous nature into a relatively thin fluid sample; and (6) capable of providing a sufficient concentration level of sample constituents of interest so as to facilitate employment with modern rapid screening/testing protocols, such as solid phase assays.

In the preferred embodiments of this invention, the collector 118 or 1118 for a saliva collection system 110 or 1110 of this invention is an inert material which exhibits a three dimensional, open and interconnecting cell structure (e.g., foam) having characteristics consistent with the foregoing sample collection and analysis requirements. In the preferred embodiments of this invention, the collector 118 or 1118 is formed of a water insoluble material, e.g., catalyzed polyvinyl alcohol polymer, of the type available from M-PACT, Intech Business Park, 1040 OCL Parkway, P.O. Box 618, Eudora, Kans. 66025 under the CLINICEL trademark and from Aspen Surgical Products 6945 Southbelt Drive, SE, Caledonia, Mich. 49316 under the brand name ULTRACEL™. Alternative materials that are believed to be suitable for the collectors of the present invention include, for example, expanded or expandable, cellular (sponge/foam) silicone materials marketed by Ipotec, Inc., 41 Industrial Drive, Exeter, N.H. 03833, hydrophilic polyurethane sponge materials, such as HYDRASORB™, available from Avitar Technologies, Inc., 65 Dan Road, Canton, Mass. 02021, and styrene-butadiene, such as white FDA sponge materials approved by the FDA.

Polyvinyl alcohol (PVA) sponges are soft and pliable when wet and semi-rigid when dry. The highly absorbent sponges are lint- and fiber-free and are capable of rapidly absorbing up to twenty (20) times their dry weight in fluids. As mentioned above, in certain embodiments of the subject invention, the PVA sponge can be lyophilized, which can further increase the absorptive qualities. Additionally, hydrocarbons, acids, alkalines and most chemicals do not adversely affect this sponge material. The polyvinyl alcohol sponges are believed to be stable toward enzymes and serological fluids, behave in water as a negatively charged colloid and strongly absorb metallic cations, such as copper or iron. The polyvinyl alcohol sponges are also believed to have a strong affinity for cationically charged ions of the quaternary ammonium type.

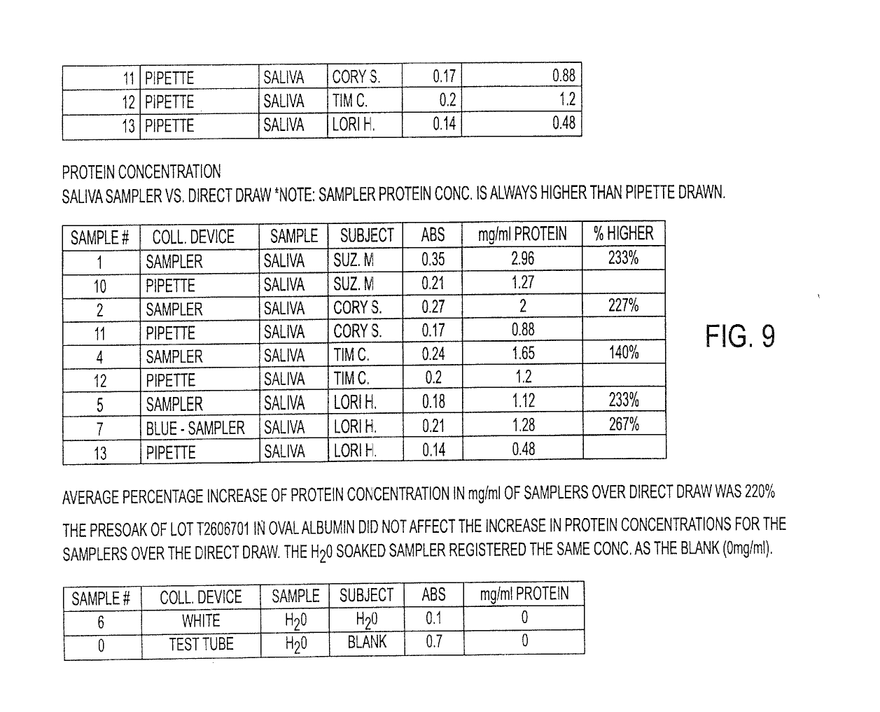

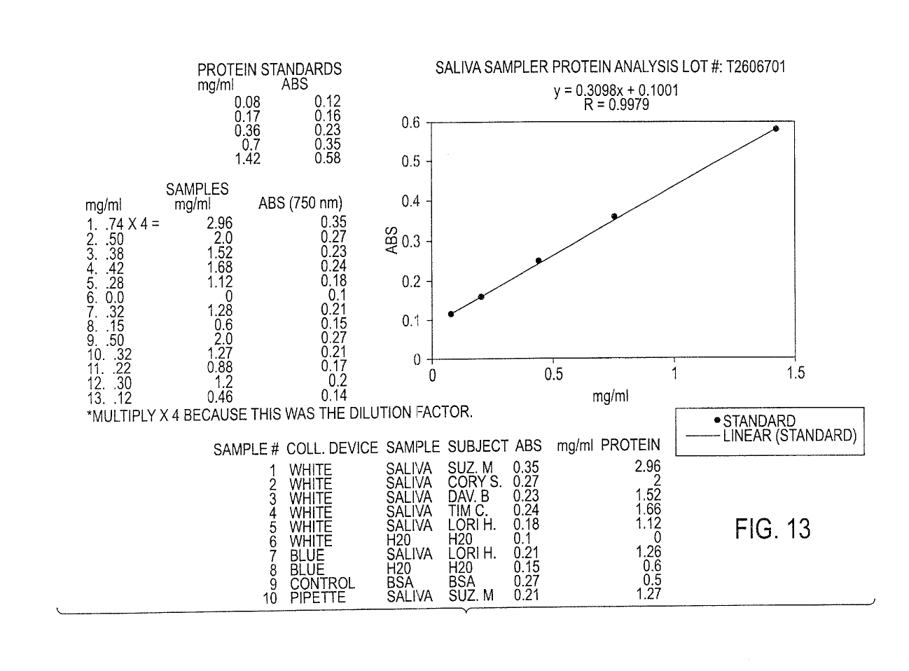

Importantly, such polyvinyl alcohol foam sponge material is capable of providing sufficient concentration levels of sample constituents of interest that sample material can be utilized with systems and devices that are typically utilized with blood plasma or serum, including, but not limited to modern rapid screening/testing protocols, such as solid phase assays, e.g., rapid HIV tests. As more specifically described below and in FIGS. 9, 10, 12 and 13, testing of such sponges demonstrates that they are capable of providing sufficient concentration levels of constituents of interest from saliva samples that are at least about 5.0 mg/ml. of fluid, and, more preferably, that are at least about 7.5 mg/ml of saliva. By comparison, concentration of a 7.5 mg/ml saliva sample provides an average percentage increase, of one or more constitutent of interest, of at least about 200% over direct pipette draw of saliva samples. This concentration can be higher by as much as four to six times depending upon the amount of sample obtained and the amount of pressure applied to the foam. Typically, the first few drops of fluid obtained by finger-squeezing or centrifuging a PVA collector of the subject invention can have the highest concentration of the analyte(s) of interest. Successive drops can also have sufficient concentration, as described above, but may not be as concentrated as the first few drops obtained. Continued pressure applied to the collector can extract further fluid, but the concentration of the analyte of interest can be further reduced and may fall below the concentration threshold necessary for detection with systems and/or devices most often used for blood serum or plasma testing.

The processing conditions, e.g., lyophilizing or freeze-drying, and composition of the foam sponge are geared to provide a very high adsorption density and sufficient tensile strength to withstand the rigors of sample collection and thereafter the recovery thereof by the compression of the foam, so as to express the sample into the collection tube via the recovery container where it can be contacted with an analyte sensitive element or dispensed onto a test strip analysis, e.g., by finger-squeezing of the recovery container.

Preferred foams for use with the collection system of the present invention are capable of being molded to size and/or compressed, such as the CLINICEL™ and ULTRACEL™ polyvinyl alcohol (PVA) sponge materials. In the context of this invention, the collector can be formed by simple and well-known fabrication methods, such as traditional molding or die cutting to shape. The sponges can also be trimmed by hand via scissors or like cutting devices. It should be appreciated that anhydrous water-miscible solvents, such as ethyl alcohol or propylene glycol, or solutions of hygroscopic salts, such as calcium chloride, will dehydrate moist polyvinyl alcohol sponge materials and render them temporarily hard, which may be useful to facilitate the cutting and shaping of them. After fabrication of the desired shapes of the polyvinyl alcohol sponges, the hardening agent(s) can be thoroughly removed therefrom by washing in water.

The collector 118 or 1118, as illustrated in FIG. 1 or 11, respectively, is shaped to approximate the internal upper space within the recovery container 116 or 1116, e.g., about 0.50″ ODx 1.7″ in length. FIGS. 18A-C illustrate an alternative embodiment wherein the collector 1818 is approximately 1.304″ in length and approximately 0.110″ in thickness. The collector 118 or 1118 is sized to be slightly larger (in length and circumference) such that a force is required to completely contain the collector 118 or 1118 within the recovery container 116 or 1116. This force can be provided when the cap 114 or 1114 is placed over and attached to the collection tube 112 or 1112, providing release of a portion of the sample from collector 118 or 1118 into the lower portion of the collection tube 112 or 1112 via the aperture 120 or 1120 of the recovery container 116 or 1116, respectively.

Referring now to FIG. 6 or 11, the collector 118 or 1118 may be separate from the cap 614 or 1114 or attached (removably or permanently) via traditional methods (FIG. 2), including in-place molding of the collector to the cap or providing complementary threading on the upper end of the element and inside the cap, so that the collector may be screwed into and out of close contact with the cap. Although molding and complementary threading is described herein, it is noted that any other suitable method for attaching or otherwise associating the collector 618 or 1118 to the cap 614 or 1114 may be used in connection with the sample collection system of the present invention. For example, the collector 618 or 1118 may be affixed to the cap 614 or 1114 via a light curing adhesive, such as ECCOBOND™ UV 9110, which is recommended for medical plastic bonding application and is available from W. R. Grace & Co.-Conn.

As alternate embodiment of the present invention, the collectors may be treated with a salivation enhancing agent, such as citric acid or flavors for stimulating a person's saliva production. Examples of appropriate flavors for stimulating the salivation glands include lemon, lime, orange or the like. Additionally, the collectors of the present invention may be pretreated with wetting agents, such as the TWEENS™, propylene ethyl glycol (PEG) such as PEG 400, etc., to modify the fluid sample from its natural viscous, fibrous and/or gelatinous state to a relatively thin and fluid sample. Generally speaking, this may be accomplished by simply creating a solution of these agents and soaking the collectors therein for a sufficient period of time as, described hereinafter in the Examples.

A person with skill in the art could readily ascertain any of a variety of agents or compounds that could be incorporated into or onto the material of the collector. Examples of such agents or compounds are those that can decrease viscosity of the saliva, have antimicrobial or antifungal properties, or provide other benefits to the collector. It is contemplated that such agents or compounds are within the scope of the subject invention.

In addition, after the collectors are pretreated in accordance with the present invention, they may be lyophilized, i.e., freeze-dried, using standard lyophilizing techniques known in the industry for storing the collectors until use. In one embodiment, a treated collector is lyophilized, i.e., freeze-dried, to preserve the chemistry of the salivating agents, wetting agents, or any other agents known to those with skill in the art, incorporated therein. Advantageously, the process of lyophilizing can provide an aseptic collector. In one embodiment, the lyophilized collector is of food-grade quality. A further advantage to lyophilizing is that it can increase the absorption capability of the collector material.

FIG. 21 illustrates an exemplary embodiment of a collector with attached handle of the subject invention.

E.) Other Embodiments

As illustrated in FIG. 4, the sample collection system 410 may include a collection tube 412 associated with another collection/testing device, such as a skirt 425. The skirt 425 is preferably provided with complementary threading along its upper portion so that the skirt 425 can be removably attached to the cap 414. Although complementary threading attachment is described herein, it is noted that any suitable means for removably associating the skirt 425 with the collection tube 412 may be used. The skirt 425 provides the function of collecting sample from the collection tube 412 for further analysis/processing without subjecting the sample to ambient conditions, i.e., avoiding contamination of the sample, and/or without exposing the surrounding environment to the collected sample, i.e., avoiding contamination/infection by the sample.

An alternate embodiment of the design of the collection tube 412 is also illustrated in FIG. 4. In this embodiment, the closed end of collection tube 412 is generally rounded.

Now referring again to FIGS. 1 and 11, as previously discussed, the collection tube 112 or 1112 of the collection device 110 or 1110 is preferably of a flexible or rigid sidewall construction, and preferably transparent to allow for observation of the sample within the sample recovery tube 112 or 1112. Thus, once the sample has been collected on the collector 118 or 1118 and the collector 118 or 1118 inserted in the recovery container 116 or 1116, the collection tube 112 or 1112 is sealed with the cap 114 or the collar 1119 of recovery tube 1116, respectively.

It is desirable from both a consumer and manufacturing perspective to provide one or more basic designs for the sample collection system of the present invention and yet permit the adaptation thereof to a particular application or user preference without departure from such basic design concept(s).

F.) Sample Collection and Recovery

In the preferred method of use of the system of this invention, the sample is obtained by contact (or immersion) of a collector with a source of a fluid suspected of containing an analyte of interest. Although the collection of a biological fluid is primarily described herein, it is noted that the system and method for use thereof of the present invention applies equally to the collection of other types of samples. For example, in the context of analysis of waste water for a toxic substance (e.g., heavy metals, organic, etc.), a representative sample of the waste water is obtained and the collector simply immersed within the sample. Regardless of the type of sample collected, the amount of such sample that needs to be absorbed to perform the desired analysis is determined ultimately by the analytical protocol, and it is assumed preferred swabbing/immersion procedures will supply more than adequate sample for the intended analysis.

Referring again to FIG. 1, employing the method of the present invention to collect a sample in the context of constituent analysis of saliva, the collector 118 of the system 110 can be readily adapted to the age of the donor (infants, toddlers, adults) and otherwise have varying porosity to make it more or less absorbent. Alternatively, the system 110 can be used with the other traditional biological fluids, (e.g., urine, whole blood, serum, etc.) and its design may thus vary accordingly. In each instance, the sample is obtained by first removal of the collector 118 from within the recovery container 116, the sample collected as above described and the sample collector 118 placed within the recovery container 116. If separated from the collection tube 112, the recovery container 116 is next placed within the collection tube 112 prior to being sealed therein using the cap 114. The act of securing the cap 114 will release at least a portion of the sample into the lower portion of the collection tube 112. In alternate embodiments and assuming that an adequate (by volume) sample has been obtained, it can thereafter be released by any one of a number of techniques, depending upon the configuration of the system 110 of the present invention, and once recovered, subject to constituent analysis. For example, in the preferred embodiments, the sides of the recovery container 116 are squeezed so as to compress the collector 118 therein and thereby release the sample from the collector 118 into the lower end of the collection tube 112 via the aperture 120 of the recovery container 116. Once the sample is released, the physical separation of the sample within the collection tube 112 from the collector 118 in the recovery container 116 prevents the recontact of the collector 118 with the released portion of the sample in the closed end of the collection tube 112.

Referring now to FIG. 11, employing a general method of the present invention to collect a saliva sample in the context of constituent analysis of saliva, the foil pack (not shown) in which the 1110 collection system is packaged, is opened and the cap 1114 is pulled from the foil package and placed between the cheek and gum of a subject for about two minutes or until the foam collector 1118 has expanded and is thoroughly wetted by the saliva. HIV positive subjects often suffer from drug-induced xerostomy or dry mouth. Thus, when the embodiments herein are utilized for HIV testing protocols, it may be necessary to place the collector between the cheek and gum for a longer period of time, for example, 3-5 minutes.

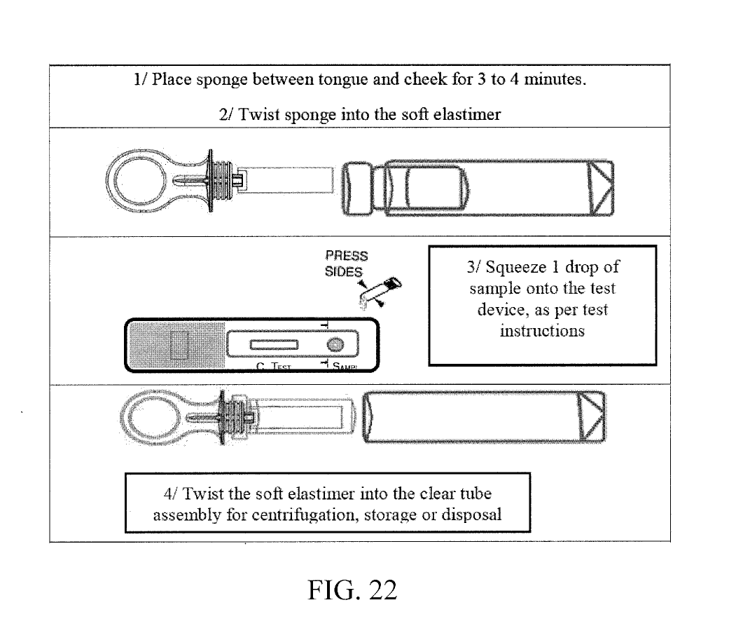

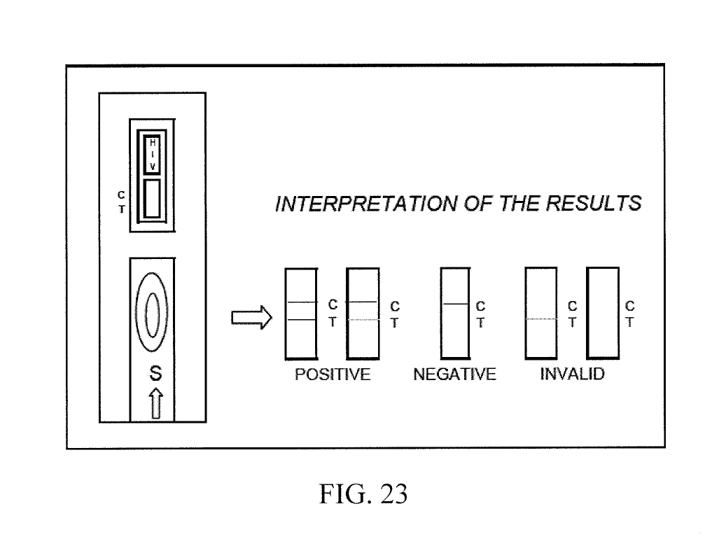

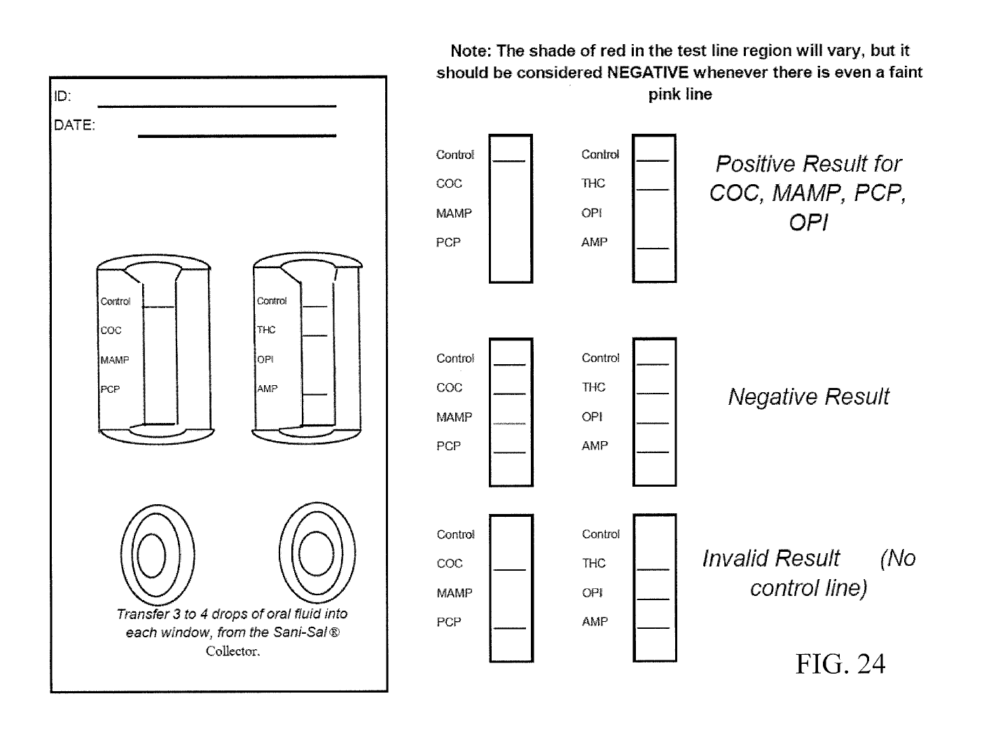

After removing the collector 1118 from the subject's mouth, and holding the collector 1118 only by the cap 1114, the collector 1118 is reassembled into the recovery tube 1116 by twisting gently to insert the wet collector 1118. The recovery tube 1116 is seated within the collector or centrifuge tube 1112. To sample or test, the recovery tube 1116 is pulled from the collector tube 1112 by the cap 1114, and while holding the cap 1114, the flexible recovery tube 1116 is finger squeezed to express into the collection tube 1112. If necessary, centrifugation can improve the yield. At this point, one or more selected test strips, such as the One Step strip tests from Health-Chem Diagnostics LLC located at 3341 SW 15th St., Pompano Beach, Fla. 33069, may be inserted into the collection tube 1112 for direct analysis of the now highly concentrated saliva sample. Alternatively, the highly concentrated saliva sample may be transferred using a calibrated dropper pipette contained in, for example, the Health-Chem Diagnostics LLC cassette type devices, e.g., RAPIDTEST HIV™ devices from Health-Chem Diagnostics LLC. In a still alternative method, the saliva may be tested immediately by finger squeezing an appropriate amount from the recovery tube directly into the sample well of a test device. FIG. 22 illustrates an example of this procedure.

Again, depending upon the specific configuration of the device of this invention, the collection and recovery of a representative sample of fluid is accomplished with relative ease and security. Although not generally recommended when dealing with samples containing a toxic and/or infectious agent, the cap 114 simply can be removed from the system to permit access to the sample within the collection tube 112, and an analyte sensitive element and/or chemicals added into the collection tube 112 and allowed to interact with the recovered sample. This method of analysis is generally undesirable since it needlessly exposes the clinician and the environment to the used collector 118 and the contents of the collection tube 112.

Where the sample is, however, suspected of containing infectious organisms, the preferred embodiment of the system selected will ensure that once the sample has been obtained, it is retained within the secure environment of the recovery container 116 and thereafter only supplied for analysis in a manner that prevents contamination of the ambient environment and those persons that must have access thereto for purposes of analysis.

Where the device of this invention does not afford access to the sample via a dispensing orifice integral with the device, or other means, the sample is generally obtained by first releasing the sample from the collector 118 through the one or more openings 120 within the recovery container 116 into the reservoir at the closed end 112c of the collection tube 112, and then removing the cap 114 and recovery container 116 from the open end 112o of the collection tube 112 of the collection system 110 (which also results in the collector 118 being withdrawn from the collection tube 112). An aliquot of fluid sample can thereafter be withdrawn from the collection tube 112 with a pipette, or the sample simply transferred to another vessel for analysis, by pouring the sample from the tube into the test vessel or via the optional channel 122 located in the closed end 112c of the collection tube 112 and described above. After at least some of the sample has been removed from the collection tube 112, the collector 118 and recovery container 116 are replaced within the collection tube 112 and the collection tube 112 is sealed with the cap 114 for storage or disposal.

The flexible sidewall design of the recovery container 116 permits the recovery of the sample from the collector 118 by compressing the foam within the tube, where the samples passes through the one or more apertures 120 in the recovery container 116 and collects in the reservoir in the bottom (closed end 112c) of the collection tube 112. The provision of an optional vent/channel (424 & 524 in FIGS. 4 and 5, respectively) in the cap 114 can improve the sample recovery process without compromising the sealing of the system by providing a way for pressure within the tubes to equalize as the sample is being released from the collector 118 and dispensed from the collection tube 112, thus minimizing the potentiality for damage to collection system 110 during the sample recovery process.

As is apparent from the above, the collection and recovery of the sample within the system of the present invention is only the beginning of the process for the determination of the presence of the analyte of interest, and, in some instances, the amount thereof. In order to accomplish such analysis, an aliquot of sample is contacted with an analyte sensitive element that is specific for the manifestation of the presence of the analyte of interest. In its simplest form, the analyte sensitive element can be one or more chemicals that are reactive with the analyte of interest, or alternatively, an elaborate chemistry system. In each instance, the analyte sensitive element can be contacted directly with the sample by the placement thereof into the recovery container and/or the collection tube, or an aliquot of sample withdrawn/dispensed from the sample recovery tube and reacted with the analyte sensitive element in a test environment that is independent of the collection device of this invention.

In the simplest embodiment of this invention, an aliquot of sample can be removed from the collection tube through the use of a pipette, straw or like device. As noted above, the preferred sample handling routine involves the use of an embodiment of the collection system including the aperture and/or a vent or channel to facilitate dispensing of a recovered sample without removal of the cap and the collector from the sample recovery tube.

As illustrated in FIG. 5, an embodiment of the collection system 510 is shown including an associated collection accessory (skirt 525). In this Figure, the collection system 510 is shown in use with an external test station 560. Using such an arrangement, an aliquot of sample is passed from the collector 518 into the reservoir located at the closed end 512c of the collection tube 512 via the aperture 520 of the recovery container 516 by the methods previously described (e.g., manual squeezing or centrifuging). Once the sample is located in the closed end 512c of the collection tube 512, the closed end 512c of the collection tube 512 is brought into close association with the test station 560 and an aliquot of the sample is passed from the collection tube 512 to the testing station 560. Prong 526 of the testing station 560 is used to access the sample within the collection tube 512 via channel 522. Reagents associated with the analysis to be performed by the test station 560 are located in association with the test disk 575. Following contact of the sample with the reagents of the test disk 575, the test is read to determine the results thereof.

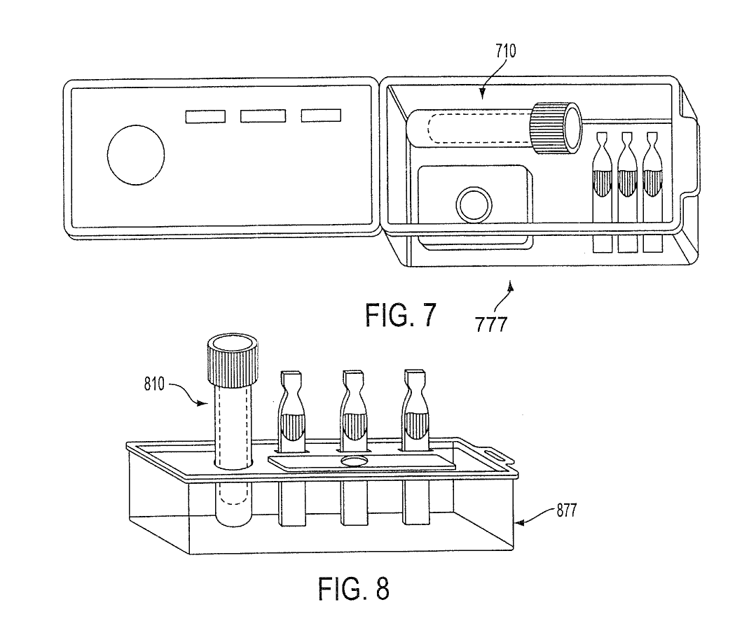

Now referring to FIGS. 7 and 8, there is shown an embodiment of the sample collection system 710, 810 as a component of a “test kit” 777, 877. Such test kits typically include all of the accessories (e.g., unit packages of reagents) and reagent system(s) needed to complete the desired analysis. For example, the sample collection system 710 is uniquely suited for use with a rapid screening for human immunodeficiency virus (HIV), the causative agent of Acquired Immune Deficiency Syndrome (AIDS), such as the RAPIDTEST HIV™ SCREEN available from Health-Chem Diagnostics LLC.

While serum has been the sample of choice for such tests, saliva samples can now be successfully employed. Using the RAPIDTEST HIV™ SCREEN protocol for saliva samples, the sample collection system 710 of the present invention is used for sample collection. The cap is removed and the collector is withdrawn from within the recovery container. Next, the collector is placed between the cheek and gum of the test subject for approximately 4 minutes or until the collector has expanded and is thoroughly wetted. Once the collector is removed from the mouth of the test subject, it is re-inserted into the flexible recovery container by twisting generally. See FIG. 11. The next step of the protocol includes releasing the sample from the collector via manual or finger squeezing or centrifuging, if required, to concentrate and drive the sample to the bottom of the collection tube. See FIG. 11. The sample is now ready to be combined with reagents, allowed to react and read for results.

FIG. 8 illustrates the sample collection system of the present invention used in connection with a workstation-type test kit.

As previously discussed, one of the most important aspects of the sample collection system of the present invention is the use of a collector, which is capable of collecting, storing and providing a sample having concentration levels of sample constituents of interest that are detectable with systems and/or devices that are typically utilized with blood serum or plasma testing, so as to facilitate their use with modern rapid screening/testing protocols, such as solid phase assays. Prior to this discovery by the inventors of the present invention, simple and inexpensive sample collections systems were incapable of delivering such a highly concentrated sample from, for example, saliva.

Various embodiments and results of the present invention will now be further illustrated with reference to the following examples. For instance, the following examples illustrate the dramatic increases in concentration levels of sample constituents of interest obtainable using the sample collection system and, more specifically, the unique collector of the present invention.

### EXAMPLE I

Referring now to FIGS. 9, 12 and 13, there is shown testing and data resulting therefrom associated with sample concentration levels produced using traditional sample collection methods (direct draw via pipette) as compared with the sample collection system of the present invention. As demonstrated in the Table of FIG. 9, the average percentage increase of protein concentration obtained by the present invention over the amount obtained using traditional direct draw methods is 220%. Accordingly, the present invention provides a clear advantage over prior art direct draw techniques associated with fluid sample collection.

A sample collection system of the present invention using CLINICEL™ polyvinyl alcohol sponges is treated with a citric acid buffer-ovalbumin wash before being lyophilized. The purpose is to determine (1) the percentage protein yield of the CLINICEL™ polyvinyl alcohol sponges that are treated with a citric acid buffer-ovalbumin wash, (2) whether the addition of the ovalbumin significantly increases the protein content, and (3) whether the saliva sampler, constructed with CLINICEL™ polyvinyl alcohol sponges that are treated with a citric acid-PEG buffer, produces a higher protein concentration than saliva drawn directly from the mouth via a plastic pipette. Five subjects volunteered.

3.5 L citric acid buffer solution, 2 M, pH 5.84, is prepared as follows: about 2.975 L of 2M trisodium citrate dihydrate is mixed with about 525 ml of 2M citric acid monohydrate at about 5.86 pH. Approximately 0.175 ml of propylene ethyl glycol (PEG) is added thereto. About 3.0 L of the citric acid buffer solution is filtered through a nylon 2 micro meter Nalgene sterilized filter. Approximately 100 mg of ovalbumin (chicken egg albumin) is dissolved in the 500 ml of unfiltered citric acid buffer solution. The citric acid buffer-ovalbumin is filtered slowly through nylon 2 micro meter Nalgene sterilized filter at about 3-4 psi to prevent foaming.

Two bags containing 250 each of CLINICEL™ polyvinyl alcohol sponges are rinsed twice with about 375 ml of the filtered citric acid buffer solution, 2 M. The solution is wrung out of the CLINICEL™ polyvinyl alcohol sponges while they are still in their bags. Approximately 250 ml of the filtered citric acid buffer-ovalbumin solution, 2M is added to each of the two bags of CLINICEL™ polyvinyl alcohol sponges and the sponges are squeezed for about 5 minutes. Thereafter, the sponges are incubated for about one hour. The sponges are again rinsed twice with about 375 ml of the filtered citric acid buffer solution, 2 M, and squeezed as dry as possible within the bags. The treated CLINICEL™ polyvinyl alcohol sponges are then laid out flat and straight on a flat pan and are freeze dried on small virtis. The treated CLINICEL™ polyvinyl alcohol sponges are frozen for about one hour, and are then condensed under vacuum. The pretreated CLINICEL™ polyvinyl alcohol sponges are then glued to the caps of the collector system with a light curing acrylate adhesive, e.g., ECCOBOND™ UV 9110.

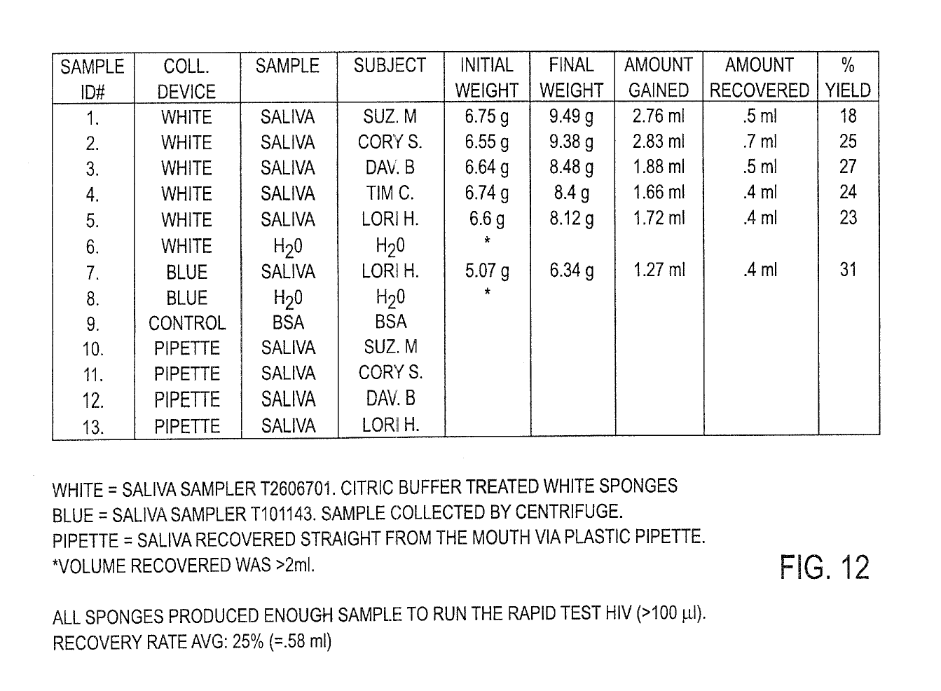

The average percentage yield is about 25% or about 580 microliters. See FIG. 12. This is more than adequate to run a strip test, such as the RAPIDTEST HIV™ SCREEN, which requires at least about 100 microliters.

To determine if the addition of about 0.02% ovalbumin increases the protein concentration, one pretreated CLINICEL™ polyvinyl alcohol sponge is soaked in deionized water and is tested in unison against the blank and saliva samples. The water soaked sample shows 0 mg/ml protein (same as the blank). Therefore, the addition of 0.02% ovalbumin is negligible. See FIG. 9.

The protein concentrations for each subject on the saliva sampler are notably higher than those obtained via direct draw. See FIG. 9. The average percentage increase of protein (in mg/ml) of samplers over direct draw is about 220%., as is shown in FIG. 9. In FIGS. 9, 12 and 13, the white collection device is the CLINICEL™ polyvinyl alcohol sponge and the blue collection device is Avitar's HYDRASORB™ sponge.

### EXAMPLE II

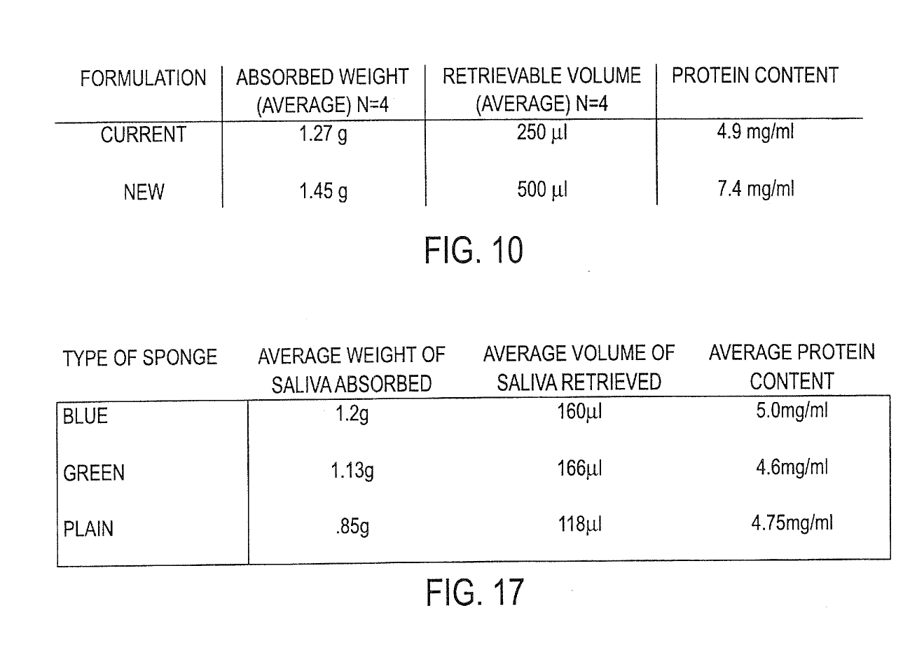

As demonstrated in the Table of FIG. 10, the sample collection system of the present invention using a CLINICEL™ polyvinyl alcohol sponge produced higher sample constituent of interest (protein) concentrations than those produced using Avitar's HYDRASORB™ sponges. In this test, collectors constructed with either a CLINICEL™ polyvinyl alcohol sponge or an Avitar's HYDRASORB™ sponge are used to collect saliva samples. Saliva samples are collected by placing the sponge being tested in the mouth of the test subject. The sponges are left in place for a period of about ten (10) minutes. Next, the sponges are weighed to record the weight of the saliva absorbed. Then the sponges are centrifuged for one (1) hour to release the sample from the collector. Thereafter, the volume of saliva released is recorded. Finally, the protein content of the collected saliva is determined according to Bio-Rad analytical method. The average results for four (4) test sponges of each type are set forth in the Table of FIG. 10. As illustrated, while the average weight (1.45 grams vs. 1.27 grams) and protein concentration (7.4 mg/ml vs. 4.9 mg/ml) are significantly increased using CLINICEL™ polyvinyl alcohol sponges as the collector versus Avitar's HYDRASORB™ sponge as a collector, respectively, the average retrieval volume (250 μl vs. 500 μl) actually decreased. This result only highlights the capability of the CLINICEL™ polyvinyl alcohol sponges as the collector of the present invention to increase the concentration of the constituents of interest from a saliva fluid sample. The capability to produce such significant increases in concentration levels allows the saliva sample collection system of the present invention to be utilized with modem rapid screening/testing protocols, such as solid phase assays.

### EXAMPLE III

The purpose of this experiment is to determine if the CLINICEL™ polyvinyl alcohol sponges and treatment protocol affect protein retention capability.

12,200 CLINICEL™ polyvinyl alcohol sponges are ordered and treated as follows with 91.5 L of citric buffer-PEG 400 wash. Using an appropriate size clean tank and mixer, approximately 91.5 L of processed water, about 4575 g sodium citrate, about 577.4 g citric acid, about 4.6 g PEG 400 and about 18.3 g methylparaben are mixed together until dissolved at about 5.52 pH. One third of solution is separated into another clean tank for combining with about 6.1 g of ovalbumin. The required quantity of sponges is removed from the freezer and allowed to thaw. This may be done up to 24 hours in advance. Discard any discolored sponges. Squeeze each bag of sponges to remove residual liquid. Filter ovalbumin solution through appropriate 0.2 micron filtration device. Deliver about 0.5 L of filtered ovalbumin solution to each bag of sponges, squeeze and allow to soak for one hour. Squeeze each bag to remove liquid after soaking. Filter the initial solution through appropriate 0.2 micron filtration device. Deliver about 0.5 L of filtered solution to each bag of sponges, squeeze to rinse again to dry. Repeat this rinse using another about 0.5 L of filtered solution per bag of sponges. Sponges should be semi-dry after rinsing and squeezing. Loosely arrange sponges in each bag to prevent excessive clumping or bending. Sponges may be frozen prior to lyophilization. Lyophilize allowing the bags to remain open. When lyophilization is completed, remove the sponges from the dryer, seal each bag, place into foil pouch, label with lot number and quantity and store at room temperature.

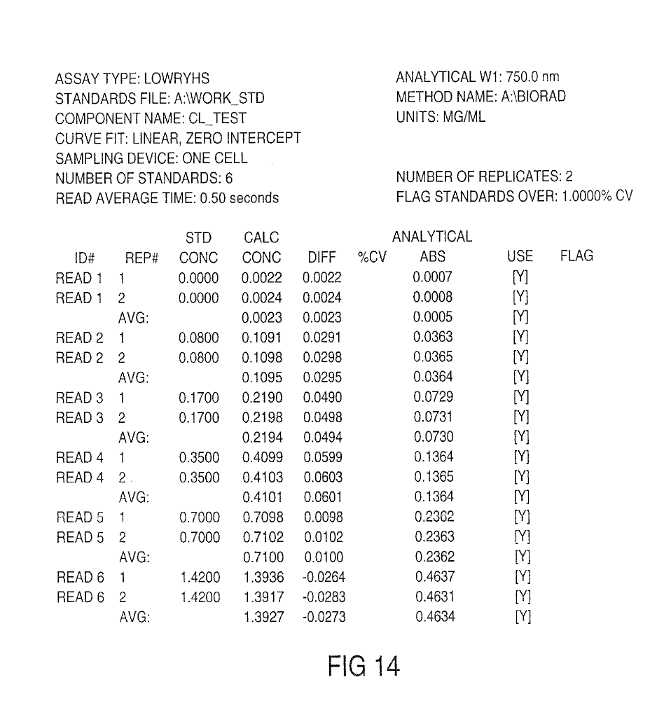

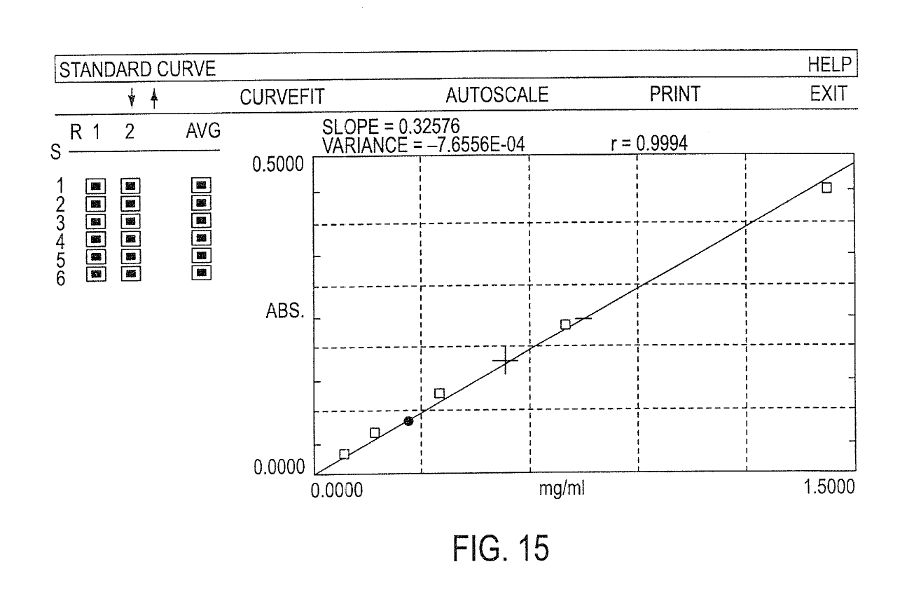

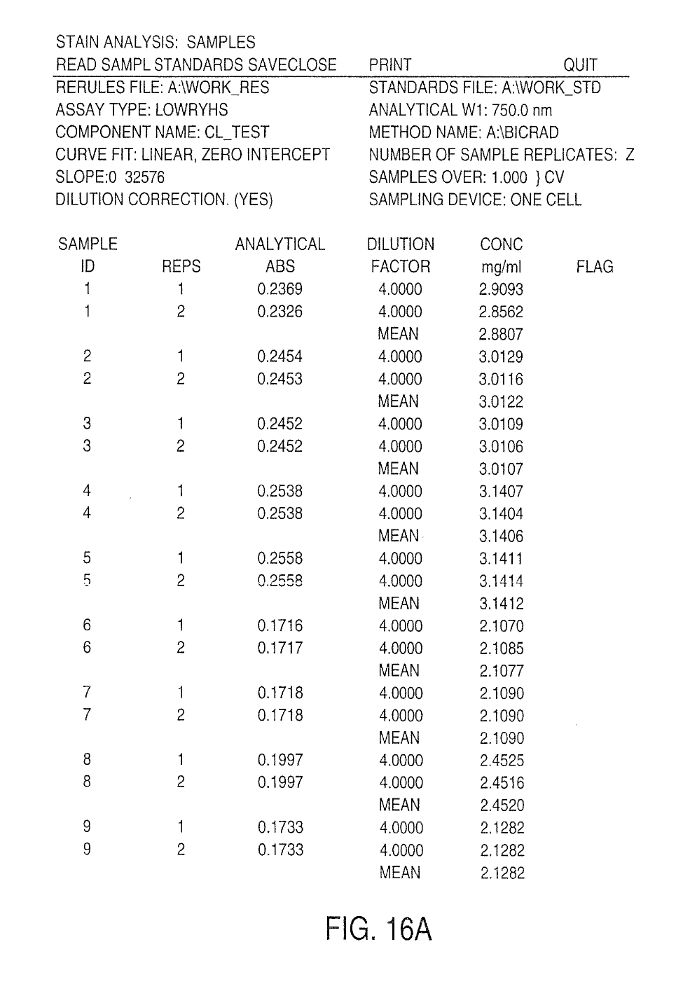

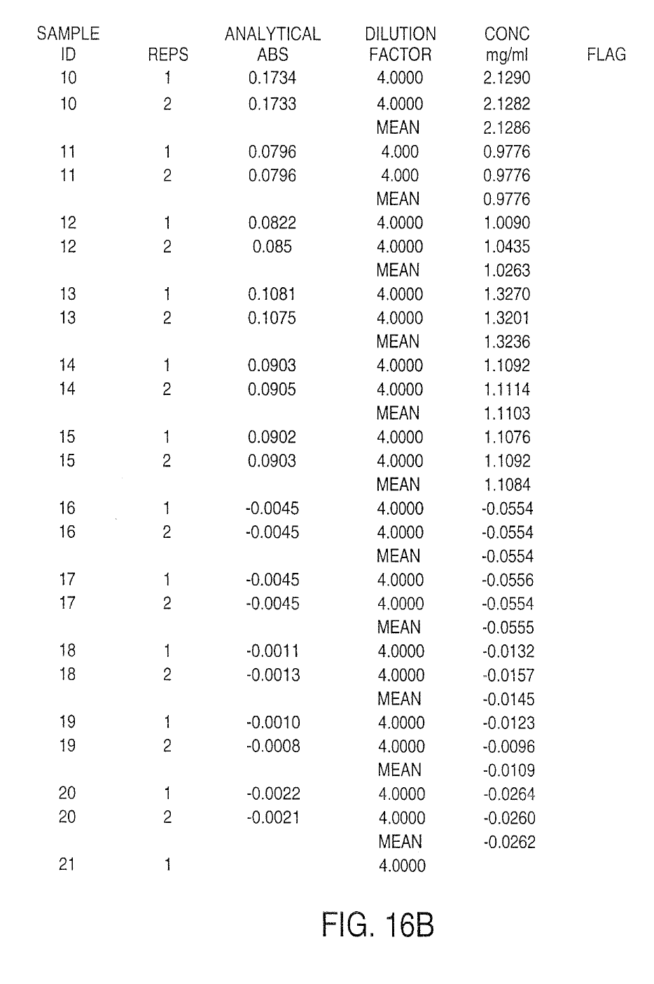

Five pretreated CLINICEL™ polyvinyl alcohol sponges are soaked in either water, about 3 mg/ml BSA standard solution, about 2 mg/ml BSA standard solution or about 1 mg/ml standard solution for about 5 minutes. Each sponge is then squeezed and the liquid expressed from the sponges is collected in appropriately labeled collection tubes. Dilute all BSA sponge solutions and standards so absorbances will fit the standard curve. Follow Bio-Rad protein assay procedure in which absorbances can be read at 750 nm. Results are shown in FIG. 14. In addition, according to FIG. 15, the average absorbance for 3 mg/ml BSA solution is about 0.25, for 2 mg/ml solution is about 0.18 and for 1 mg/ml is about 0.9. Further results are shown in FIG. 16, wherein (1) the five sponges exposed to the 3 mg/ml BSA solution, samples 1-5 therein in FIG. 16, expressed protein in a concentration on average of about 3.04 mg/ml, (2) the five sponges exposed to the 2 mg/ml BSA solution, samples 6-10 therein in FIG. 16, expressed protein in a concentration on average of about 2.16 mg/ml, (3) the five sponges exposed to the 1 mg/ml BSA solution, samples 11-15 therein in FIG. 16, expressed protein in a concentration on average of about 1.11 mg/ml, and (4) the five sponges exposed to water, samples 16-20 therein in FIG. 16, expressed protein in a concentration on average of about 0.018 mg/ml.

### EXAMPLE IV

Three different Avitar HYDRASORB™ sponges, designated as blue, green and plain, are evaluated as collectors in accordance with the present invention. The evaluation method involves three individuals. The amount of time that the Avitar sponges are in the mouths of the individuals varies from about 10 minutes (2 subjects) to about 30 minutes (one subject). The performance of the Avitar HYDRASORB™ sponges is determined by: (1) weight of saliva absorbed, (2) volume of saliva retrievable after centrifugation for one hour, and (3) the protein content of the collected saliva that is determined by an analytical method available from Bio-Rad. The results indicate no significant difference in the weight of saliva absorbed or the volume of saliva that is collected between the blue or green Avitar HYDRASORB™ sponges. See FIG. 17. However, the plain Avitar HYDRASORB™ sponge is about 28% lower in both categories. The protein content varies about 508% amongst the sponges with the blue Avitar HYDRASORB™ sponge having the highest value at about 5 mg,/ml. See FIG. 17.

The present invention may, of course, be carried out in other specific ways than those herein set forth without departing from the spirit and essential characteristics of the present invention. Thus, even though certain embodiments of sample collection systems envisioned by the present invention have been illustrated in the accompanying Figures and described in the foregoing Summary of the Invention, Detailed Description and Abstract, it will be understood that the invention is not limited to the embodiments disclosed, but contemplates numerous rearrangements, modifications and substitutions without departing from the spirit of the present invention, as set forth and defined by the following claims. For example, the present invention contemplates those various alternative sample collection systems disclosed and described in PCT International Application No. PCT/US96/16075 and PCT International Publication No. WO 97/12681, which are incorporated herein by reference in their entireties, so long as the objectives of the present invention are followed and not defeated. The present embodiments are, therefore, to be considered in all respects as illustrative and not restrictive and any changes coming within the meaning and equivalency range of the appended claims are to be embraced therein.

All patents, patent applications, provisional applications, and publications referred to or cited herein are incorporated by reference in their entirety, including all figures and tables, to the extent they are not inconsistent with the explicit teachings of this specification.

It should also be understood that any reference in this specification to “one embodiment,” “an embodiment,” “example embodiment,” “further embodiment,” “alternative embodiment,” etc., is for literary convenience. The implication is that any particular feature, structure, or characteristic described in connection with such an embodiment is included in at least one embodiment of the invention. The appearance of such phrases in various places in the specification does not necessarily refer to the same embodiment. Further, when a particular feature, structure, or characteristic is described in connection with any embodiment, it is submitted that it is within the purview of one skilled in the art to affect such feature, structure, or characteristic in connection with other ones of the embodiments.

We claim:

1. A collection system for collecting, storing and dispensing a sample, having, or suspected of having at least one constituent of interest, said collection system comprising:
a recovery container having a first closed end with an aperture therethrough, a second end having an opening therein, and sidewalls that define an interior contiguous with the opening in the second end and the aperture in the first closed end;
a cap for cooperatively engaging with the opening in the second end of the recovery container;
a collector connected to the cap, such that when the cap is cooperatively engaged with the recovery container opening, the collector is inserted within the interior of the recovery container; and,
a collection tube having a first end that is closed, a second end having an opening therein, and sidewalls that define an interior contiguous with the opening in the second end, wherein the first end of the recovery container can be inserted into the opening in the second end of the collection tube, such that at least a portion of the recovery container resides within the interior of the collection tube and the sidewalls of the recovery container cooperatively engage with and seal the opening in the second end of the collection tube,
wherein the collector is capable of collecting and storing the sample; and wherein the collector is further capable of expressing therefrom a constituent of interest at a concentration level that is more concentrated than the concentration level in the sample from which it was initially collected.

2. The collection system, according to claim 1, wherein the collector comprises an absorbent material capable of wicking fluids.

3. The collection system, according to claim 2, wherein said absorbent material is water insoluble.

4. The collection system, according to claim 3, wherein the absorbent material is a polyvinyl alcohol sponge.

5. The collection system, according to claim 4, wherein the polyvinyl alcohol sponge is treated with one or more of wetting or salivating agents.

6. The collection system, according to claim 5 wherein the polyvinyl alcohol sponge is lyophilized.

7. The collection system, according to claim 6, wherein the polyvinyl alcohol sponge is aseptic.

8. The collection system, according to claim 1, wherein the cap further comprises a handle capable of facilitating contact with the collector device without direct contact with the saliva sample.

9. The collection system, according to claim 1, wherein the collector further comprises a plug for insertion into the collecting container.

10. The collection system of claim 1, wherein the recovery container includes a flexible sidewall construction for permitting finger squeezing thereof.

11. The collection system, according to claim 1, wherein the collector further comprises a wetting agent for modifying the collected saliva sample from its viscous, fibrous and/or gelatinous nature into a relatively thin fluid sample.

12. The collection system, according to claim 1, wherein the collector is capable of expressing therefrom the constituents of interest at a concentration level that is detectable with testing systems and/or devices typically utilized for blood serum or plasma samples.

13. The collection system, according to claim 1, wherein the aperture is sized to dispense the sample as droplets, when pressure is applied to the sidewalls of the recovery container; wherein the droplets have a concentrated volume of approximately 50(+5) microliters.

14. The collection system, according to claim 1, wherein the aperture has a diameter of between approximately 1.0 mm and 2.0 mm.

15. A method for collecting and storing a sample containing an analyte of interest and expressing the analyte therefrom using a collection system comprising:
a recovery container having a first closed end with an aperture therethrough, a second end having an opening therein, and sidewalls that define an interior contiguous with the opening in the second end and the aperture in the first closed end;
a cap for cooperatively engaging with the opening in the second end of the recovery container;
a collector connected to the cap, such that when the cap is cooperatively engaged with the recovery container opening, the collector is inserted within the interior of the recovery container; and,
a collection tube having a first end that is closed, a second end having an opening therein, and sidewalls that define an interior contiguous with the opening in the second end, wherein the first end of the recovery container can be inserted into the opening in the second end of the collection tube, such that at least a portion of the recovery container resides within the interior of the collection tube and the sidewalls of the recovery container cooperatively engage with and seal the opening in the second end of the collection tube,
wherein the collector is capable of collecting and storing the sample; and wherein the collector is further capable of expressing therefrom constituents of interest in concentrations levels that are more concentrated than theconcentration levels in the sample from which they are expressed,
said method comprising,
placing the collector in contact with the sample to be recovered for a period of time sufficient to absorb an amount of the sample;
inserting the collector with the sample through the opening in the second end of the recovery container and into the interior of the recovery container;
engaging the cap with the second end of the recovery container;
inserting the first end of the recovery container through the opening in the second end of the collection tube until the side walls of the recovery container cooperatively engage with the opening in the second end of the collection tube to provide an assembled and transportable collection system.

16. The method of claim 15, wherein the biological fluid sample is saliva.

17. The method, according to claim 16, wherein the collector further comprises a salivating agent for inducing production of said saliva sample.

18. The method, according to claim 16, wherein the collector further comprises a wetting agent for modifying the collected saliva sample from its viscous, fibrous and/or gelatinous nature into a relatively thin fluid sample.

19. The method of claim 15 further comprising centrifuging the assembled collection system to extract the fluid sample through the aperture into the collection tube.

20. The method, according to claim 15, further comprising dispensing at least one drop of concentrated sample directly onto a testing device.
